(19) United States
(12) Patent Application Publication
(10) Pub. No.: US 2024/0338573 A1
(43) Pub. Date: Oct. 10, 2024

(54) SYSTEMS AND METHODS FOR ENABLING AUTOMATED TRANSFER LEARNING

(71) Applicant: HUAWEI TECHNOLOGIES CO., LTD., SHENZHEN (CN)

(72) Inventors: Xu LI, Kanata (CA); Weisen SHI, Kanata (CA)

(73) Assignee: HUAWEI TECHNOLOGIES CO., LTD., SHENZHEN (CN)

(21) Appl. No.: 18/747,639

(22) Filed: Jun. 19, 2024

Related U.S. Application Data
(63) Continuation of application No. PCT/CN2021/141056, filed on Dec. 24, 2021.

(51) Int. Cl. G06N 3/096; G06N 3/04

(52) U.S. Cl. CPC G06N 3/096; G06N 3/04

(57) ABSTRACT

A method and system for training an artificial intelligence (AI) model with a network platform deploying routines on a network edge. The network platform includes at least one AI enabler, associated to a routine manager, and topologically located between a routine client function and a routine server function implementing a routine; a service manager including an AI hyper-parameter optimizer; and a data selector filtering data from a routine client function to an AI enabler. A routine client function can represent a data source, an AI enabler can implement a classifier of an AI model, and a routine server function can implement a classifier of the AI model.

### CROSS-REFERENCE TO RELATED APPLICATIONS

This application is a continuation of International Patent Application No. PCT/CN2021/141056, filed on Dec. 24, 2021, the disclosure of which is hereby incorporated by reference in its entirety.

### TECHNICAL FIELD

This invention pertains generally to the field of network-based computing services and in particular, to systems and methods for a computer service to implement transfer learning of an artificial intelligence model.

### BACKGROUND

Edge computing (EC) is a way of computing that reduces transmission delay and bandwidth consumption by moving computation and storage close to the network edge, and therefore to the end user. Typical edge computing applications include applications having large bandwidth and/or stringent delay requirements, such as artificial intelligence (AI) applications, augmented realty (AR) and virtual reality (VR) games, machinery, etc. As edge computing techniques develop into maturity, edge computing capabilities and platforms (i.e. edge clouds) can be deeply deployed in the network, e.g. on radio node, and be widely available for use.

Networks based on 6G can enable connected intelligence, in addition to connectivity to intelligence. Connected intelligence is essentially distributed computing or network-based computing), and involves at least two computing modules, each one potentially deployed at a different network location, e.g. on an edge cloud. The at least two computing modules can each perform part of the computing, and exchange the results with one another to achieve a common goal, or accomplish a mission. Central to distributed computing is coordination between the computing modules in the computing process to ensure goal achieving or mission accomplishment. Conventially, coordination is often performed at the application layer. Computing modules are interoperable as they are programmed to communicate or interact with each other using an appropriate language (i.e. well-defined signals) at right times, e.g. at a time instants, upon certain events, or following some pre-defined procedure.

In a 6G network, it is envisioned that reusability can be an important aspect of connected intelligence. Some intelligence providers can deploy intelligences, i.e. applications or computing applications, in the network, e.g. on edge clouds, and publish their availability to other application providers, which can reuse them as computing modules to generate further, or next-generation intelligences. Making intelligences reusable can avoid redundant development of similar intelligences, and can boot an eco-system to be centered around the network. When computing modules are developed by different provider however, interoperability among the computing modules can become an issue.

Therefore, there is a need for methods and/or systems that can obviate or mitigate the limitations of the prior art, by allowing an interconnected computer service to implement transfer learning of an artificial intelligence model.

This background information is provided to reveal information believed by the applicant to be of possible relevance to the present invention. No admission is necessarily intended, nor should be construed, that any of the preceding information constitutes prior art against the present invention.

### SUMMARY

Embodiments of the present invention address the issue of interoperability between applications and provide systems and methods for supporting and/or enabling reuse of applications in a network setting, where composite computing modules of a computing service are potentially located at different network locations.

In embodiments, a device accessing a first computing service can reuse part of a second service, wherein each service is an artificial intelligence service in which a work can, for example, be related to training an AI model. For a transfer learning to occur, such as a transfer of data from a second AI service to a first AI service, a network implementing a first and a second AI service can determine which existing service to reuse, and it can support the reuse by providing the second AI service. In embodiments, a provider of a first AI service and a provider of a second AI service do not necessarily interact with each other.

In some embodiments, a transfer learning can involve transferring data or features from a source domain to a target domain, in order to train a target AI model. Transferring data can be referred to as a data transfer mode and transferring features can be referred to as a feature transfer mode.

Technical effects of the present methods include the ability to perform transfer learning on an AI model, such as neural network, encoded on an AI enabler located on a network implementing two computing services.

Embodiments include a method executed by an artificial intelligence (AI) hyper-parameter optimizer for transferring parameters between two applications comprising: obtaining, from a network entity, information indicating an application category of an AI model; determining an encoder structure of an encoder for the AI model; and configuring an AI enabler, according to the encoder structure; wherein the AI enabler is operative to transfer the parameters between two applications according to the AI model. A non limiting technical effect of such an embodiment can allow the optimizer to determine a suitable encoder, thus simplifying a service provider's implementation of an AI model.

In embodiments, the method can further include determining whether transfer learning can be applied. In embodiments, this can include determining whether a data transfer mode can be applied, whether a feature transfer mode can be applied and whether a mixed feature transfer mode can be applied. A non limiting technical effect of such an embodiment can allow simplification of an AI model development.

In embodiments, determining an encoder structure can comprise an AI hyper-parameter optimizer further comprising determining whether transfer learning can be applied, and determining a transfer learning mode and associated transfer learning information, wherein associated transfer learning information includes any of: parameters of the encoder, parameters of the source of training data, parameters for initializing the encoder, and information about a data source from which data can be transferred to train the AI model.

In embodiments, a method can further comprise an AI hyper-parameter optimizer classifying the AI model into a model class, and identifying parameters of the model class. A non limiting technical effect of such an embodiment can allow transfer learning to happen at a per model class granularity instead of per AI-mode-pair granularity, reducing management overhead.

In embodiment, a method can further include the AI hyper-parameter optimizer calculating weighted means of the parameters of the model class.

In embodiments, a method can further comprise an AI model further comprising an encoder comprising layers, and a classifier comprising layers. A non limiting technical effect of such an embodiment can allow the encoder and the classifier to be separately developed and managed.

In embodiments, a method can further comprise an AI enabler operative to obtain data from the routine client function, to convert the data into an internal representation of an AI model, and to send the internal representation of an AI model to the routine server function

In embodiments, a method can further comprise an AI enabler operative to obtain data from the routine client function, to convert the data into an internal representation of an AI model, and to send the internal representation of an AI model to the routine server function

In embodiments, a method can further comprise an AI enabler implementing an encoder comprising layers including at least one input layer. In embodiments the AI enabler evaluates at least one loss function during a training stage of the AI model.

In embodiments, a method can further comprise at least one privacy router further comprising a data selector operative to filter out data having a negative impact on a target AI model, and to send a set of selected training data to the AI enabler.

In embodiments, a method can further comprise a routine client function representing a source of training data, and a routine server function implementing a classifier.

In embodiments, a method can further comprise a routine client function representing a source of training data, and a routine server function implementing a classifier.

In embodiments, a method can further comprise an AI enabler obtaining from the routine server function, border gradients computed from the internal representation of the AI model; indicating to the routine client function to continue sending training data; and obtaining more training data from the routine client function, until a training data set has been processed.

In embodiments, a method can further comprise an AI hyper-parameter optimizer obtaining information describing one or more goals of the AI model, and obtaining information describing properties of the training data.

In embodiments, determining whether a feature transfer mode can be applied can comprise the AI hyper-parameter optimizer attempting to identify a model class of the AI model; and determining, if such a model class is successfully identified, that the feature transfer mode can be applied.

In embodiments, determining whether a data transfer mode can be applied can comprise an AI hyper-parameter optimizer attempting to identify a training data set, associated with a second AI model, that is similar to the training data set associated with the AI model, determining, if a training data set is successfully identified, that the data transfer mode can be applied.

In embodiments, a method can further comprise an AI hyper-parameter optimizer providing the AI enabler with information indicating the encoder structure, such that the information can be mapped from the information indicating the application category, to the AI enabler.

In embodiments, a method can further comprise an AI hyper-parameter optimizer determining whether there is sufficient training data, in the training data set associated with the AI model for a data transfer mode to be applied.

In embodiments, a method can further comprise an AI hyper-parameter optimizer sending a configuration request to the AI enabler, and receiving a configuration response from the AI enabler, wherein the configuration request to the AI enabler includes any of: information identifying the computing service, information identifying the routine, information identifying the AI model, encoder structure information, loss function information, information related to a transfer learning for the AI model, and information about the privacy router(s).

In embodiments, a method can further comprise an AI hyper-parameter optimizer sending a configuration request to a privacy router coupled to the AI enabler, and receiving a configuration response from the privacy router coupled to the AI enabler, wherein the configuration request to the privacy router includes any of: information identifying the computing service, information identifying the routine, instruction to activate a data selector, routing information related to the service function instance, and routing information related to an AI enabler.

Embodiments include a method of registering a computing service registration, comprising a first service manager that includes an artificial intelligence (AI) hyper-parameter optimizer receiving a service registration request from an application controller; determining model hyper-parameter information for a first AI model, according to the service registration request; requesting from a second service manager operative to authorize a data transfer, an authorization for a data transfer; receiving from the second service manager, an authorization response; and instantiating the computing service according to the model hyper-parameter information; wherein the service registration request includes information identifying the first computing service, and service description information (SDI) of the first computing service. A non limiting technical effect of such an embodiment can allow providing information to determine data transfer and initiate authorization of the data transfer.

In embodiments, instantiating a computing service according to a model hyper-parameter information can comprise the first service manager that includes an artificial intelligence (AI) hyper-parameter optimizer sending to an orchestrator operative to perform a computing service orchestration, a service instantiation request; receiving from the orchestrator, a request to configure a compute plane for the computing service; configuring the compute plane for the computing service; sending to the orchestrator, a response indicating that configuring the compute plane is complete, the orchestrator being further operative to send to a second service manager, a request to configure the compute plane for a second computing service; wherein the second service manager is operative to configure the compute plane for the second computing service. A non limiting technical effect of such an embodiment can allow orchestration to optimize resource usage and compute plane composition and structure jointly across multiple computing services, when data transfer between the two services is to be applied.

Other embodiments provide an apparatus for implementing a computing service including a processor and at least one non-transitory machine readable medium storing machine readable instructions which when executed by the processor, configures the apparatus for: obtaining, from a network entity, information indicating an application category of an AI model; determining an encoder structure of an encoder for the AI model; and configuring an AI enabler, according to the encoder structure; wherein the AI enabler is operative to transfer the parameters between two applications according to the AI model.

Other embodiments provide apparatus for implementing a computing service including: a processor; and at least one non-transitory machine readable medium storing machine readable instructions which when executed by the processor, configures the apparatus for executing the methods described and claimed herein.

Other embodiments provide a system comprising a plurality of devices in communication with each other for executing the methods described and claimed herein.

The foregoing and other objects, features, aspects and advantages of the present invention will become more apparent from the following detailed description, taken in conjunction with the accompanying drawings which description is by way of example only.

### BRIEF DESCRIPTION OF THE DRAWINGS

FIG. 1 illustrates an AI model, according to embodiments.

FIG. 2 illustrates interactions between a routine client function, an AI enabler, and a routine server function, according to embodiments.

FIG. 3a illustrates transfer learning in the feature transfer mode, according to embodiments.

FIG. 3b illustrates transfer learning in the data transfer mode, according to embodiments.

FIG. 4 illustrates an architectural view of a network system, according to embodiments.

FIG. 5 illustrates network entities that can be added to a system architecture, according to an embodiment.

FIG. 6a illustrates how an AI hyper-parameter optimizer given input information can determine transfer learning, according to an embodiment.

FIG. 6b illustrates how an AI hyper-parameter optimizer given input information can determine transfer learning, by determining if there is sufficient training data in a training data set associated with the AI model, according to an embodiment.

FIG. 6c illustrates how an AI hyper-parameter optimizer can generate a model class, according to an embodiment.

FIG. 7 illustrates a procedure of service registration for a first computing service, initiated by an application controller (AC), according to an embodiment.

FIG. 8 illustrates compute plane entities for routine P and routine Q, according to an embodiment.

FIG. 9 illustrates a service instantiation procedure, in accordance with embodiments.

FIG. 10 is a procedure for configuring a compute plane for a routine, according to embodiments.

FIG. 11 illustrates a procedure for configuring a routine manager, according to an embodiment.

FIG. 12 illustrates a procedure for configuring an AI enabler, according to an embodiment.

FIG. 13 illustrates a procedure for configuring a privacy router, according to an embodiment.

FIG. 14 is a block diagram of an electronic device (ED) illustrated within a computing and communications environment that may be used for implementing the devices and methods disclosed herein.

It will be noted that throughout the appended drawings, like features are identified by like reference numerals.

### DETAILED DESCRIPTION

In the following, “network-based computing service”, “computing service”, “intelligence service”, “service”, “application” and “intelligence” are equivalent and used inter-changeably, unless clarified otherwise, and in a network, a computing service can be provided by one or more service functions.

Scenarios of intelligence reuse (i.e. reuse of an intelligence) can be classified into two categories: application-driven reuse and network-driven reuse.

Application-driven reuse is a reuse scenario, where the reuse is determined at the application layer. The network is informed of the reuse by the application layer and supports the reuse. An example is progressive learning, where an AI model in a first AI service or application is extended to solve a new problem for a second AI service. A provider of the second AI service may obtain information about the AI model from the provider of the first AI service, and develop the second AI service accordingly.

The present disclosure relates to network-driven reuse, which corresponds to scenarios where the reuse is not determined by the application layer, but by the network. In embodiments, network-driven reuse is particularly related to transfer learning, such as transferring knowledge (parameters or data) from a first AI service to a second AI service. The network can determine which existing service (i.e. the first AI service) to reuse (i.e. to transfer knowledge from) and it can support the reuse by providing auxiliary intelligence. In this scenario, a provider of the second AI service and a provider of the first AI service do not necessarily interact with each other.

Transfer learning involves transferring data or transferring features, respectively referred to as a data transfer mode (where what is transferred is data) and a feature transfer mode (where what is transferred is a feature, e.g. AI mode parameters), from a source domain to a target domain, in order to train a target AI model that is associated to the target domain.

When transfer learning is in the data transfer mode, the transferred data has previously been used to train a source AI model that is associated with the source domain, and it is then used as training data for the target AI model during the transfer learning, possibly after some filtering or selection.

When transfer learning is in the feature transfer mode, the transferred features includes model parameters associated with the source AI model, and the model parameters are used to initialize the target AI model during the transfer learning.

A network-based computing service is an application-layer service that performs network-based computing. It includes one or multiple works, which are considered as belonging or associated to the service. The works are exposed to service consumers, i.e. entities consuming or using the service, that can choose to participate, join in, or contribute to an execution of the work. In the following, “network-based computing service”, “computing service”, “intelligence service”, “service” and “application” are equivalent and used inter-changeably, unless clarified otherwise.

A work of a service includes one or multiple tasks. The tasks are considered to belong or to be associated to the service. There can be dependency between the tasks. When a first task depends on a second task, because, for example, the first task requires the computing or execution result of the second task as input, the first task should be executed after the second task has been executed. Such dependency can be indirect, that is, the first task can depend on the second task as a result of depending on a third task that depends on the second task. When the first task does not depend on the second task, the first task can be executed before, or in parallel (in time) to the second task. A dependency between tasks is referred to as an inter-task dependency or an intra-work dependency.

A task of a service includes one or multiple routines, which can each correspond to a computing or networking step of the task. The one or multiple routines are considered to belong or to be associated to the service. There can be dependency between the routines. When a first routine depends on a second routine, because, for example, the first routine requires the computing or execution result of the second round as input, the first routine will have to be executed after the second routine has been executed. This dependency may be indirect, that is, the first routine depends on the second routine as a result of depending on a third routine that depends on the second routine. When the first routine does not depend on the second routine, the first routine can be executed before, or in parallel (in time) to the second routine. A dependency between routines is referred to as inter-routine dependency or intra-task dependency.

A routine of a service is associated with a first service function and a second service function. The first service function does not represent devices and is referred to as routine server function. The second service function may or may not represent one or more devices and is referred to as routine client function. The two service functions are considered to belong or to be associated to the service and each of them can have one or more instances. An instance of the routine server function is referred to as a routine server, and an instance of the routine client function is referred to as a routine client. A routine can be associated with a synchronization requirement specifying how a routine client should communicate with a routine server, e.g. in parallel or in sequence, with respect to other routine clients. A routine server can be associated with one or more routine clients, and the one or more routine clients can communicate with the routine server in accordance with synchronization requirements during an execution of the routine.

A service function of a service implements a computing module of the service. The service function can be a virtual function, e.g. in the form of software. When the service function is a virtual function, the service function can be deployed or instantiated at one or multiple network locations, such as e.g. edge clouds, referred to as deployment locations. After the service function is deployed or instantiated at a network location, there is an instance of the service function, e.g. in the form of a copy of the software implementing the service function, at the network location. The service function can represent devices, implying that the computing module running on the devices. In such a case, the devices are considered instances of the service function.

When needed, e.g. upon request or on certain events, a work associated with a computing service is executed. During an execution of the work, the tasks included in the work are executed according to inter-task dependency (or intra-work dependency) associated with the work such that the inter-task dependency is not violated. During an execution of a task, the routines included in the task are executed in accordance with the inter-routine dependency (or intra-task dependency) associated with the task, such as the inter-routine dependency is not violated. During an execution of a routine, data communications happen between a routine server and one or multiple routine clients associated to the routine server, in accordance with synchronization requirements associated with the routine, such that the synchronization requirement is met or satisfied.

An AI application is an example of a computing service in which a work can, for example, be related to training an AI model, implemented as a service function. The work can include the following tasks: a data collection and preparation task, a model training task, and a model validation task, wherein the model validation task depends on the model training task, that in turn depends on the data collection and preparation task. Another work of the AI application can be, for example, AI inference.

In some embodiments, a computing service is associated with an AI model, such as a deep neural network (DNN) based model. The AI model can be split into an encoder and a classifier. The encoder includes the input layer, and possibly one or more hidden layers, which are layers between the input layer and the output layer, while the classifier includes the remaining hidden layers, if any, and the output layer. In general, an encoder captures low-order features of the AI model and tends to be sharable with other similar AI models, i.e. AI models with a similar goal or solving a similar problem. A classifier captures high-order features of the AI model and tends to be goal-specific.

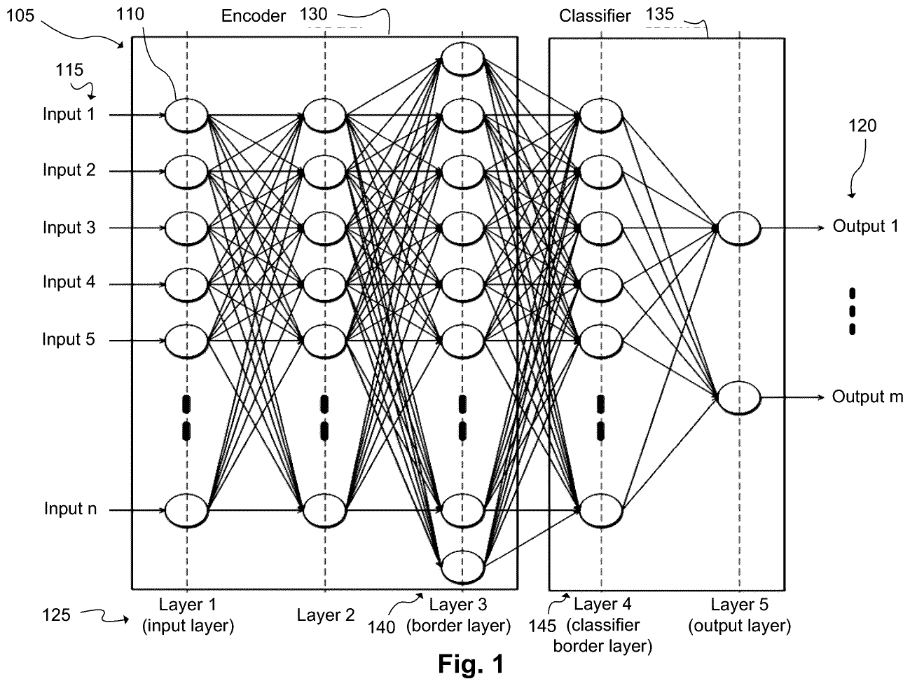

FIG. 1 illustrates an AI model, according to embodiments. The AI model 105 can include multiple nodes 110 (i.e. neurons) representing interconnect mathematical functions that can take input values 115 and produce output values 120. The nodes can be organized into layers 125. The AI model 105 can be split into an encoder 130 and a classifier 135. In a case with five layers as in FIG. 1, layer 1 can be referred to as an input layer, layer 2, layer 3, and layer 4 can be known as hidden layers, and layer 5 can be called the output layer. Furthermore, layer 3 (140) can be referred to as an encoder border layer, and layer 4 (145) can be referred to as a classifier border layer.

In embodiments of the present disclosure, an encoder 130 is network-supplied in that it is provided by the network and implemented by a network entity, referred to as an AI enabler.

In embodiments, a classifier 135 is customer-supplied in that it is provided by the computing service provider, and implemented by a service function of the computing service. That service function can be deployed at a network location and be run on an application server (AS) at the network location. The AS can be a network entity different from the AI enabler.

The service function implementing a classifier 135 is associated to a routine of the computing service as a routine server function. The corresponding routine client function for the routine is, or represents, a data source, i.e. a training data set. The AI enabler is topologically placed between the routine server function and the routine client function When the routine is being executed, the routine client function sends input data to the network, and the data is routed to the AI enabler, which then processes the data and converts it to an internal representation (internal to the AI model). The AI enabler sends the internal representation (i.e. the processed data) to the routine server function, and the routine server function further processes it and computes an output (which includes one or multiple output elements, e.g. in the form of a vector).

If the routine is related to inference using the AI model, the input data sent by the routine client function is inference data, and the output is the inference result. The routine server function can provide the output to the routine client function 205 (or to some other network entity), e.g. along a backward path.

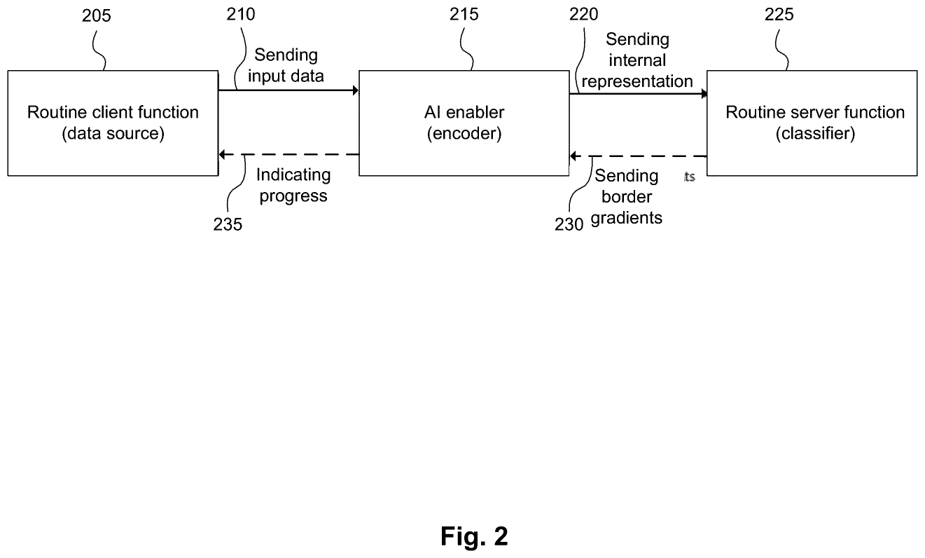

FIG. 2 illustrates interactions between a routine client function, an AI enabler, and a routine server function, according to embodiments. A routine of a computing service includes a routine client function 205 and a routine server function 225. The routine client function 205 is a data source and the routine server function 225 implements a classifier 135. When the routine is being executed, the routine client function 205 sends 210 input data to be routed to the AI enabler 215. The AI enabler 215 processes and converts the data to an internal representation of the AI model, and sends 220 the internal representation to the routine server function 225 implementing the classifier, which produces an output.

If the routine is related to training of the AI model, the above described procedure corresponds to a forward propagation, and the input data sent 210 is training data. The routine server function 225 evaluates a loss function based on the output. If necessary, depending on the evaluation, the routine server function 225 initiates a backpropagation.

During a backpropagation, the routine server function 225 computes gradients, referred to as border gradients, because they are related to the border layers: layer 3 (140) and layer 4 (145). The routine server function 225 can send 230, via the network, the board gradients to the AI enabler 215, which can continue the backpropagation accordingly.

After backpropagation to the AI enabler 215, the AI enabler can indicate, by indicating 235 progress to the routine client function 205, to continue sending 210 input (training) data. The routine client function 205 then does so accordingly, and forward propagation, and possibly backpropagation, can repeat as described above.

In some embodiments, a routine P of a first computing service is related to a training of a first AI model, which can be trained during an execution of the routine P. The first AI model includes a network-supplied encoder 130 and a customer-supplied classifier 135. In embodiments, if the training of the first AI model supports transfer learning, the network can accordingly determine to apply the transfer learning during the routine execution, i.e. during the training of the first AI model. In this case, the routine P corresponds to the target domain of the transfer learning, and the first AI model is the target AI model of the transfer learning. The network can further determine the source domain of the transfer learning and the mode of the transfer learning (i.e. the mode that the transfer learning runs in), which is one of: the feature transfer mode, the data transfer mode, and the mixed transfer mode as described below.

When the mode of transfer learning is the feature transfer mode, the transfer learning involves a feature transfer, and the source domain of the transfer corresponds to a model class to which the target AI model belongs. In this case, model parameters associated with the model class correspond to features to be transferred. The model parameters are used to initialize the encoder 130 of the target AI model during the transfer learning, and can be referred to as encoder parameters. In some embodiments, after the target AI model (its encoder 130) is initialized using the encoder parameters, the target AI model is further trained using a training data set associated with the target domain.

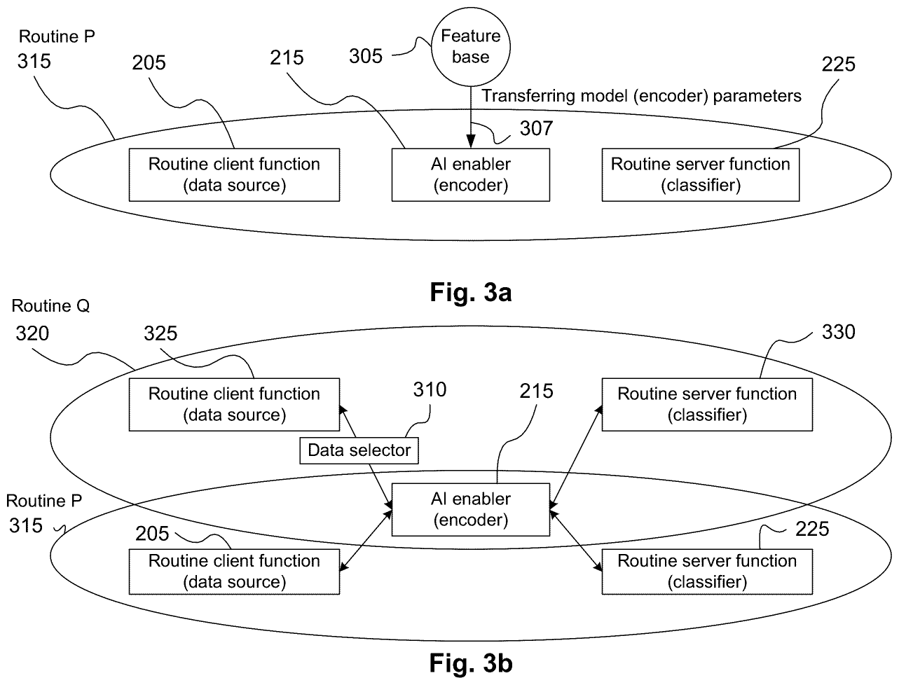

FIG. 3a illustrates transfer learning in the feature transfer mode, according to embodiments. In the feature transfer mode, a feature base 305, storing encoder parameters for model classes, transfers 307 encoder parameters to an AI enabler 215 implemented as an encoder 130. The AI enabler 215 is located between a routine client function 205 acting as a data source, and a routine client server 225 implementing a classifier 135, the two forming a routine P 315.

When the mode of the transfer learning is the data transfer mode, the transfer learning involves a data transfer, and the source domain of the transfer corresponds to a routine Q in a second computing service, the routine Q being related to the training of a second AI model. The second AI model in this case is the source AI model of the transfer learning. The first AI model and the second AI model share the same encoder 130, which is provided or implemented by an AI enabler 215.

FIG. 3b illustrates transfer learning in the data transfer mode, according to embodiments. An AI enabler 215 implementing an encoder 130 is part of a routine Q 320. A data transfer corresponds to a reuse of the routine Q, for the training of the target AI model, as described below. When the routine P 315 is executed to train the target AI model using a training data set associated with the routine P, from its routine client function 205, the routine Q 320 is also executed to train the source AI model using a training data set associated with the routine Q 320, from its routine client function 320. During the training of the two models, the encoder 130 shared by the two models is trained jointly using both training data sets. The routine Q 320 is reused to transfer the training data set associated with the routine Q 320 to the routine P 315 to train the target AI model, or more precisely, to train the encoder of the target AI model. The training data set associated with routine Q 320 can be provided to the AI enabler 215 via a data selector 310, which can selectively send the training data (data in the training data set) to the AI enabler 215 so as to filter out data having a negative impact on the target AI model. To support such data transfer, the AI enabler 215 implements an evaluator module and functionality, which separates model-specific features and shared features within its encoder 130, between the source domain and the target domain.

When the mode of transfer learning is a mixed transfer mode, the transfer learning involves both a feature transfer and a data transfer.

Network-based computing can be supported by a network system, also referred to as platform, which includes a control plane and a compute plane. The control plane includes a number of control plane entities, e.g. access manager, service manager, work manager, task manager, orchestrator, resource manager, and service data repository. The compute plane includes a number of compute plane entities, e.g. one or more routine managers, and one or more privacy routers. These entities, whether control plane entities or compute plane entities, are network entities. The links between these entities indicate interfaces or connections that they use to interact or communicate with each other. In some embodiments, the resource manager is an external entity, not part of the network system.

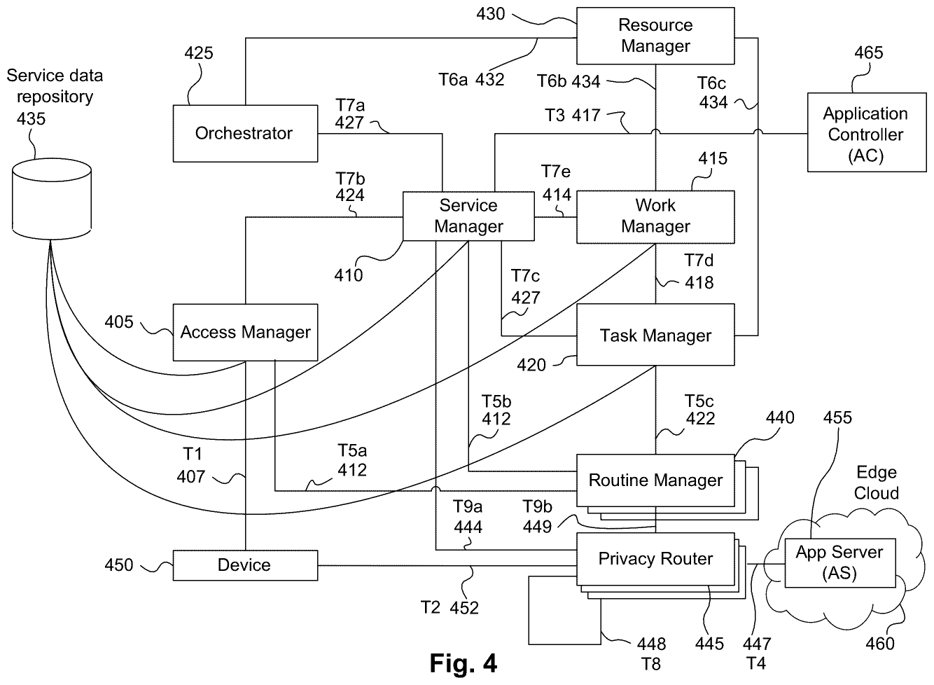

FIG. 4 illustrates an architectural view of a network system, according to embodiments.

Network entities of such a system can be logical entities. Any of them can be combined into a same entity. In some embodiments, the control plane entities are integrated into (or implemented by) a same network entity, e.g. a platform controller or a system controller. The platform controller implements or provides the control plane's functionalities. In some embodiments, some of the control plane entities are integrated into (or implemented by) a same network entity. For example, an orchestrator can be merged into a service manager, or a service manager and a work manager can be combined to form a service and work manager, or a work manager and a task manager can be combined into a work and task manager. In some embodiments, the compute plane entities, i.e. routine manager and privacy router, can be combined into a coordinator.

The functionalities of the above network entities can be described as follows.

In embodiments, an orchestrator 425 can determine deployment locations of service functions for an application, and it can select a compute plane for the application, including a logical topology of the compute plane. It can also determine the resources needed at the deployment locations and over the communication links in the logical topology; and it can interact with a resource manager 430 (which in some embodiments can be in the infrastructure network) to provide computing and networking resources (i.e. radio resources, transport resources, etc.) accordingly

In embodiments, an access manager 405 can act as a control plane interface with a device; and perform mobility management for the device 450. It can also authenticate and/or authorize a device to connect to a platform, e.g. the network system illustrated in FIG. 4.

In embodiments, a service manager 410 can perform registrations, registration updates, and deregistrations for a computing service. It can also authenticate and authorize a device to use an application. It can also act as a control plane interface with external entities, such as application controllers 465. It can also select a work manager 415 to handle a work order.

In embodiments, a work manager 415 can execute a work or handle a work order. This can include receiving a work order related to a work from a service manager 410 and coordinating the execution of tasks of the work according to inter-task dependency. A work manager can also dispatch a task order related to a task, which can include selecting a task manager and sending a task order to the selected task manager. A task order can be received from a service manager or generated by a work manager. A task order can be associated with a work execution. In some embodiments, a task order can trigger the execution of a work that includes a related task.

In embodiments, a task manager 420 can execute a task or handle a task order. This can include receiving a task order related to a task from a work manager and coordinating the execution of routines of the task according to inter-routine dependency. A task manage can also trigger a routine execution, which can include allocating an identification (ID) for the routine execution, identifying one or more routine managers associated with the routine, and notifying the routine managers to execute the routine. This can further include allocating a differentiator for the routine execution.

In embodiments, a service data repository 435 can store user subscription data, as well as a service profile for each registered computing service.

In embodiments, a routine manager 440 can perform routine synchronization. This can include triggering data communication between a routine client and a routine server according to a synchronization requirement associated with the routine. It can also provide k-anonymity, including ensuring the participation of at least a minimum number k of devices in the routine execution when the routine involves devices.

In embodiments, a privacy router 445 can provide signal and data routing. This can include forwarding compute plane control signals and data traffic during the execution of a routine. A privacy router can also perform proxy re-encryption on out-going data traffic before forwarding, to allow or support user and device privacy and data confidentiality at the same time.

In embodiments, a resource manager 430 can manage and provision computing and network resources, according to resource requirements received from an orchestrator.

In an embodiment, an application controller (AC) 465 can belong to, or be controlled by, a service provider, and it can represent the service provider. An AC can connect to a service manager via an interface or connection T3 417, in order to manage the computing service, for example, to register or deregister a service, to update the registration of a service, or to trigger an execution of a work of the service. An AC can be integrated with an application server (AS), or it can be a separate entity from an AS.

When or after a computing service is registered on a platform, service functions of the service can be deployed at selected network locations and they can connect to a compute plane selected for the computing service. Each of the network locations can be identified by an ID such as a DNAI or an IP address. The compute plane can include one or more privacy routers 445 and routine managers 440. The privacy routers 445 can be interconnected via interfaces or connections T8 448. The service function instances or the ASs hosting them can each connect to a privacy router in the compute plane via an interface or connection T4 447. During an execution of the routine, two service function instances (i.e. a routine client and a routine server) associated with the routine can communicate via their associated, connected privacy routers.

An AC 465 can send a work order to the platform, which can accordingly trigger the execution of a work identified in the work order, by signaling proper service function instances and forwarding subsequent data traffic between the service function instances, according to inter-task dependency and intra-task dependency within the work.

The device 450 connects to a privacy router 445 associated with a routine server of the routine. The device connects to the privacy router via an access network (AN) node, which is connected with the privacy router 445 through an interface or connection T2 452. The AN node can be a radio access node (e.g. a cellular base station, a satellite, a drone, or a WiFi access point) or a wireline access node. The device participates in the routine execution by communicating with the routine server as routine client via the privacy router during the routine execution. The device can be a UE, an IoT device, a server, a drone, a satellite or any communication device that register with the network system as device (and is recognized by the network system as a device).

Embodiments include solutions for enhancing a network system to support automated transfer learning, by adding new network entities (or modules) that can include an AI enabler 215, an AI hyper-parameter optimizer, and a data selector 310, to the network system. In some embodiments, these new network entities are independent entities. In some embodiments, the AI enabler 215 is an independent entity. The AI hyper-parameter optimizer can be added into the service manager 410, and the data selector 310 can be added into the privacy router 445. Embodiments further include procedures for service registration and service instantiation that are compatible with the enhanced network system architecture.

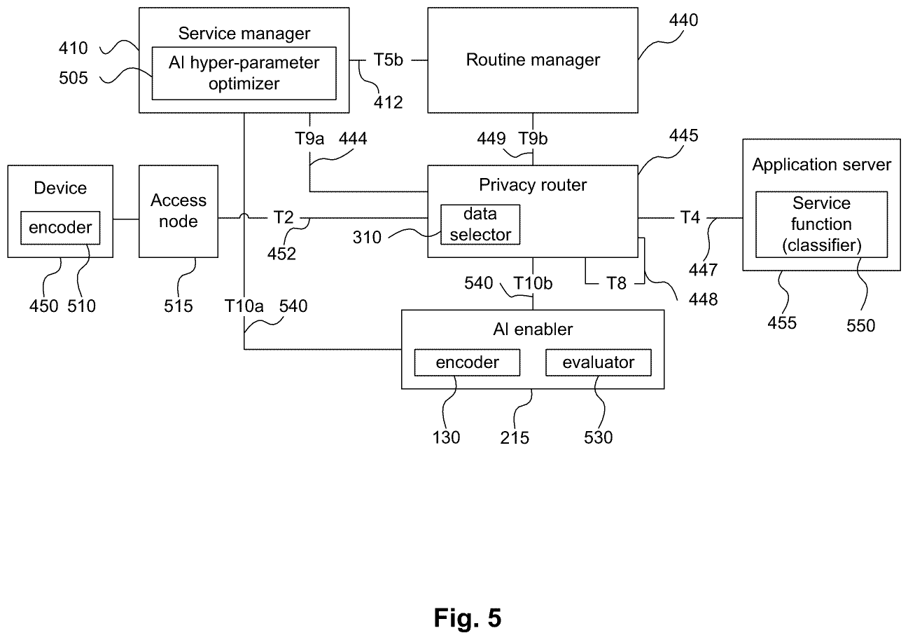

FIG. 5 illustrates network entities that can be added to a system architecture, according to an embodiment. The following describes functionalities of the network entities or modules according to embodiments. A service manager 410 includes an AI hyper-parameter optimizer 505. A privacy router 445 includes a data selector 310. An AI enabler 215 implements an encoder 130 and an evaluator 530, and is connected to a privacy router 445. Further, a device 450 includes an encoder 450, and an application server 455 includes a service function implementing a classifier 550.

An AI model 105 belongs to, or is associated with an application category, and an application category is associated with or corresponds to an encoder structure (or an encoder for simplicity). AI models associated to the application category can apply a network-supplied encoder 130 that bears the corresponding encoder structure. These AI models can solve different problems or achieve different goals, by having different customer-supplied classifiers. For example, AI models that use a convolutional neural network (CNN) to conduct image or video processing are categorized as “computer vision”, and AI models that use RNN-based methods for text segmentation, speech recognition, etc., are categorized as “natural language processing”. CNN and RNN are two types of deep neural networks (DNN).

An AI hyper-parameter optimizer 505 receives or obtains, from a network entity, information indicating an application category to which an AI model is associated. The network entity can be the application controller (AC) 465 representing the service provider, or the service data repository 435, which stores the information as part of a service profile. The AI hyper-parameter optimizer 505 determines, according to the application category of the AI model, the encoder structure to be used for the AI model, and configures an AI enabler 215 accordingly. Although the encoder structure for AI models associated with a same application category can be identical, the model parameters associated to the encoder 130 (e.g., weights and bias on neurons) for the AI models may be different. When configuring the AI enabler 215, the AI hyper-parameter optimizer 505 provides or transmits information indicating the encoder structure to the AI enabler 215, in that the information can be mapped from the information indicating the application category, to the AI enabler 215.

A target AI model (e.g. the AI model 105) can be associated with an application category and a training data set. Data in the training data set is used to train the target AI model. If training of an AI model (e.g. the target AI model) supports transfer learning, the AI hyper-parameter optimizer 505 determines whether to apply the transfer learning during the training of the AI model. There are three transfer learning modes:
the feature transfer mode,
the data transfer mode,
the mixed transfer mode.

If the AI hyper-parameter optimizer 505 determines to apply transfer learning, the AI hyper-parameter optimizer 505 further determines how to apply the transfer learning, i.e. a transfer learning mode to be used by the transfer learning, or in other words, a transfer learning mode that the transfer learning runs or operates in.

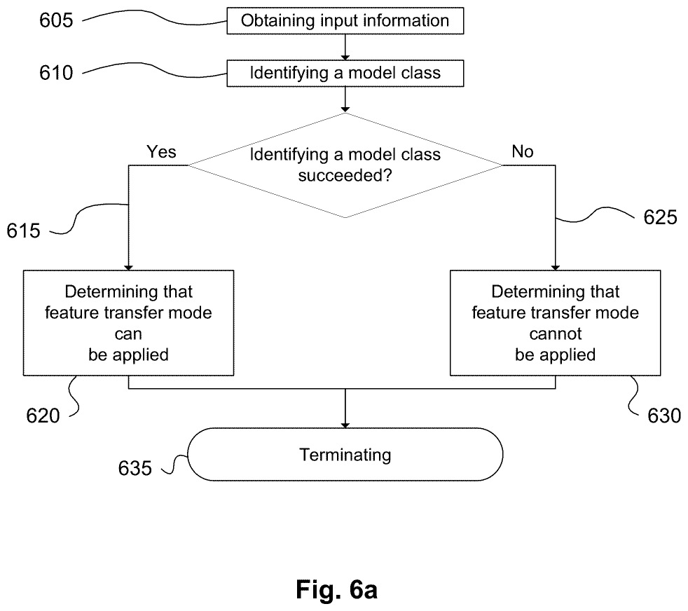

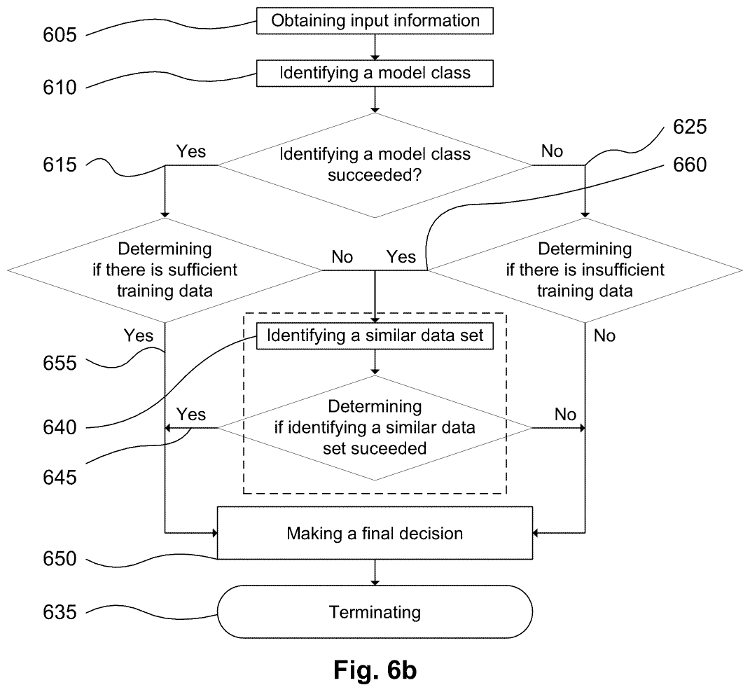

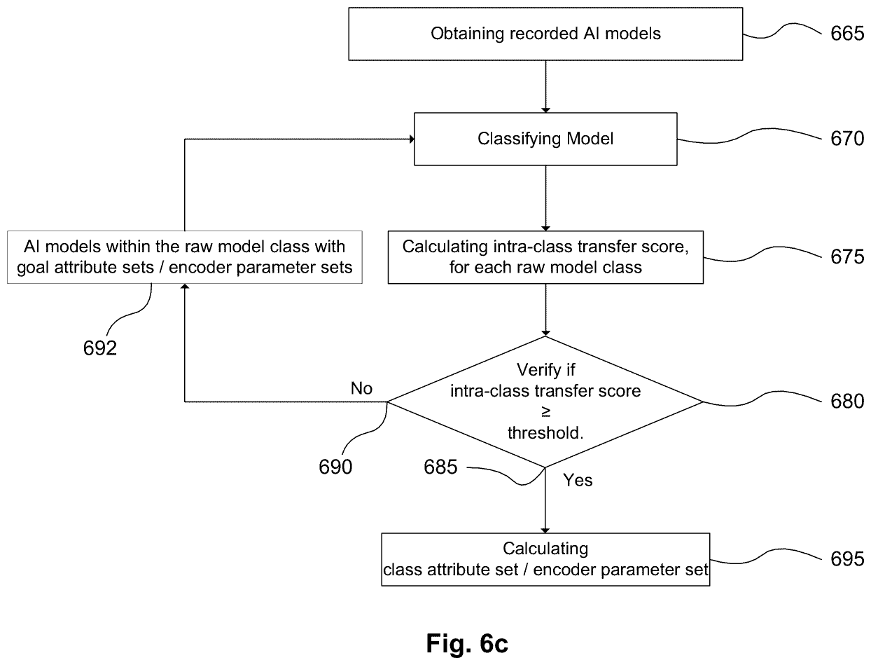

FIG. 6a illustrate how an AI hyper-parameter optimizer 505 given input information can determine transfer learning, according to an embodiment.

The AI hyper-parameter optimizer 505 can receive or obtain 605 input information from a network entity, which can for example be the application controller (AC) 465 representing the service provider, or a service data repository 435 storing the information as part of a service profile. The input information can include information indicating the application category, information describing the model goal of the AI model, and/or information describing properties of the training data set.

The AI hyper-parameter optimizer 505 can determine whether the feature transfer mode can be applied. To do so, the AI hyper-parameter optimizer 505 can try identifying 610 a model class that the AI model belongs to. If identifying a model class has succeeded 615, the AI hyper-parameter optimizer 505 can determine that the feature transfer mode can 620 be applied. If identifying a model class has not 625 succeeded, the AI hyper-parameter optimizer 505 can determine that the feature transfer mode cannot 630 be applied. In either case, the process can subsequently terminate 635. The model class corresponds to the source domain of the feature transfer.

In another embodiment, the AI hyper-parameter optimizer 505 can determine whether the data transfer mode can be applied. To do so, the AI hyper-parameter optimizer 505 can try identifying 640 a training data set of a second AI model, that is similar to the training data set associated with the first AI model. If identifying such a training data set has succeeded 645, the AI hyper-parameter optimizer 505 can make 650 a final decision as to whether the data transfer mode can be applied. The different AI model associated with the training data set corresponds to the source domain of the data transfer. In another embodiment, the AI hyper-parameter optimizer 505 can determine whether both the data transfer mode and the feature transfer mode can be applied. In that case, the mode is referred to as mixed transfer mode.

In an embodiment, before determining whether the data transfer mode can be applied with a similar data set 645, the AI hyper-parameter optimizer 505 can determine if there is sufficient training data in the training data set associated with the AI model.

FIG. 6b illustrates how an AI hyper-parameter optimizer given input information can determine transfer learning by determining if there is sufficient training data in a training data set associated with the AI model, according to an embodiment.

If the training data set contains 655 sufficient data, the AI hyper-parameter optimizer 505 can decide that trying to identify 640 a similar data set should not be applied, and it can make 650 a final decision that the data transfer mode should not be applied.

If the training data set does not 660 contain sufficient data, then the AI hyper-parameter optimizer 505 can proceed to try identifying 640 a training data set of a second AI model, that is similar to the training data set associated with the first AI model.

If a final decision 650 is that the feature transfer mode and the data transfer mode can both be applied, the AI hyper-parameter optimizer 505 can determine to apply the transfer learning in the mixed transfer model. If one of the two modes can be applied, the AI hyper-parameter optimizer 505 can determine to apply the transfer learning in that mode. If neither of the two modes can be applied, the AI hyper-parameter optimizer can determine to not apply the transfer learning. If the AI hyper-parameter optimizer 505 determines to apply the feature transfer mode or the mixed transfer mode, the AI hyper-parameter optimizer must have identified 610 a model class that the AI model belongs to. In this case, the AI hyper-parameter further determines to transfer encoder parameters associated with the model class to the AI model (e.g. initiating an encoder of the AI model using the encoder parameters) during the transfer learning. This is further described below, e.g. when describing encoder parameter information.

After a final decision has been made, a process can terminate 635.

The following describes how the AI hyper-parameter optimizer 505 can identify 610 a model class and, and how it can identify 630 a similar training data set for an AI model (e.g. the AI model 105).

An AI model (e.g. the AI model 105) is associated to, assigned with, or belongs to, an application category. The application category can be associated to, assigned with, or can contain or include one or multiple AI models. The application category is associated with an attribute set that includes one or multiple attributes. Each of the one or multiple attributes corresponds to a basic problem related to the application category (i.e. AI models that belong to the application category). The AI hyper-parameter optimizer 505 can receive or obtain 605 information identifying the application category.

The AI model is associated with a goal (model goal), which corresponds to a target problem that the AI model resolves. The AI hyper-parameter optimizer 505 can receive or obtain 605 information describing the model goal. The model goal can be described or expressed by a list of attribute values of the AI model, which can be organized or stored in a vector format. In this case, the information describing the model goal includes the list of attribute values. Each of these attribute values corresponds to an attribute (i.e. a basic problem) in the attribute set of the application category and indicates a weight of the corresponding basic problem in the target problem. For instance, the attribute sets of an application category related to computer vision (CV) can be the following: [“margin recognition”, “texture recognition”, “background filter”, “video/figure compression”, “variance detection from continuous figures”, “objective recognition in video”]. The target problem of an AI model within this application category can be to recognize a cat from input pictures. The list of attribute values, i.e. model goal, of the AI model can be: [0.3, 0.3, 0.4, 0, 0, 0].

The application category is associated with one or multiple model classes. Each AI model within the application category belongs to, or is assigned to, one of the one or multiple model classes. A model class can include (or be assigned with) one or multiple AI models. AI models with similar goals are assigned to the same model class. For example, within an application category related to object recognition, a first AI model uses a CNN to recognize a “cat” from figures, and a second AI model uses a CNN (with different neuron weights from the first AI model's CNN after being trained) to recognize a “dog” from the figures. The two AI models can be assigned to the same model class.

A model class is associated with an encoder parameter set that includes encoder parameters representing joint features of AI models associated, assigned, or belonging to the model class. The encoder parameters of the model class are computed or determined based on encoder parameters of AI models (e.g., weights and biases of neurons in each AI model's encoder) associated with the model class. In some embodiments, the encoder parameters of the model class is computed or determined as the weighted mean of the AI models' encoder parameters, or as the encoder parameters of an AI model achieving highest mean transfer learning performance, according to statistical data.

For an AI model (e.g. the AI model 105) associated with an application category, the AI hyper-parameter optimizer 505 tries to identify a model class for the AI model within the application category by performing model class assignment. When performing model class assignment, the AI hyper-parameter optimizer 505 assigns or associates the AI model to a model class associated to the application category, the model class being the identified model class. The AI hyper-parameter optimizer 505 identifies the model class according to goal similarity as described below.

Each model class is associated with a goal (class goal) that represents the joint goal of AI models assigned to the model class. The class goal is described or expressed by a list of attribute values of the model class, each of which can be calculated as weighted mean of the corresponding attribute values of the AI models assigned to the model class. The list of attribute values of the model class (i.e. the class goal) can be organized or stored in a vector format. The AI hyper-parameter optimizer compares the model goal of the AI model (provided by the service provider) and the class goal of every model class in the application category. The AI hyper-parameter optimizer 505 identifies a model class such that the similarity level (goal similarity level) between the model goal and the class goal is higher (or not lower) than a threshold value. In some embodiments, the goal similarity level is measured or evaluated using, and is inversely proportional to a distance (e.g. vector distance) between the model goal and the class goal. Note that if multiple such model classes exists, the AI hyper-parameter optimizer 505 can identify one with the highest similarity level, or an arbitrary one among the multiple such model classes. The AI hyper-parameter optimizer 505 assigns the AI model to the identified model class.

To support the model class assignment described above, one or multiple model classes are generated previously according to historical data which records feature transfer performance between AI models within the application category. The one or multiple model classes can be generated by the AI hyper-parameter optimizer 505. The model classes are generated in four general steps including model classification, intra-class transfer score calculation, class split, and calculating class goal and encoder parameters for each class.

FIG. 6c illustrates how an AI hyper-parameter optimizer can generate a model class, according to an embodiment.

Initially, given the model goals of multiple AI models, the model goal being represented in the form of lists of attribute values and/or encoder parameter sets, the AI hyper-parameter optimizer 505 can obtain 665 the recorded AI models.

Then, the AI hyper-parameter optimizer 505 can classify 670 the recorded AI models, as samples, into one or multiple raw classes, based on model goal vectors, by applying to them a clustering algorithm to generate model classes. AI models with similar model goals (in terms of attribute values) are classified into the same model class. The initial number of model classes can be pre-determined as a parameter of the clustering algorithm, or be autonomously determined by the clustering algorithm.

Then, for each raw model class, the AI hyper-parameter optimizer 505 can conduct transfer learning tests, in feature mode, between sample AI models. To do so, the AI hyper-parameter optimizer 505 can calculate 675 an intra-class transfer score. An intra-class transfer score calculation can be performed as follows. Within each model class, a sufficient number of transfer learning (in the feature transfer mode) tests can be conducted between two sample AI models. For each test, the two AI models are randomly selected from the same model class and the test performance is recorded in the form of a performance matrix. The performance matrix can include information indicating prediction accuracy, accumulative gain, convergence speed, etc. A weighted mean score of all tests' performance is calculated for each model class, which is referred to as intra-class transfer score. The higher intra-class transfer score indicating good transfer learning performance between any two AI models within the model class (e.g., high prediction accuracy, large accumulative gain, and fast convergence speed.

Then, for each raw model class, the AI hyper-parameter optimizer 505 can verify 680 if an intra-class transfer score is greater, or in some embodiments, is not smaller, than a threshold value.

If “Yes” 685, i.e. if an intra-class transfer score is greater (or not smaller) than the threshold value, then for each class, the AI hyper-parameter optimizer 505 can calculate the class goal vector and the encoder parameter set, e.g., weighted means of the encoder parameter sets of AI models within the class, which are trained through transfer learning tests.

If “No” 690, i.e. if an intra-class transfer score is not greater (or is smaller) than the threshold value, then the AI hyper-parameter optimizer 505 can conduct the class split process by re-applying model classification 670 and intra-class transfer score calculation 675 steps to the AI models 692 within the raw model class to be split. A class split can happen iteratively until intra-class transfer scores of all model classes are greater (or are not smaller) the threshold value.

Then, given a class split result (i.e. the final model classes), the AI hyper-parameter optimizer 505 can calculate 695 the class goal (e.g. represented in form of a list of attribute values) and the encoder parameters for each model class.

The generated model classes are kept trained and updated gradually by the AI hyper-parameter optimizer 505, or on an on-going basis according to feature transfer perform feedback. In some embodiments, the feedback includes a performance matrix (e.g., prediction accuracy, accumulative gain, convergence speed) of the feature transfer learning supported by the platform.

When a new AI model is assigned (or associated) with a model class, both the class goal and encoder parameter set of the model class are re-calculated by adding the new AI model's model goal and encoder parameter set into calculations.

If the similarity level between the model goal of a new AI model and the class goal of the associated model class are lower (or not higher) than a threshold value, a new model class is added or created with the class goal being the same as the model goal, and the encoder parameter set of (i.e. encoder parameters associated with) the new model class being the same as the encoder parameters of the new AI model.

For each model class, the intra-class transfer score can be re-calculated periodically, or after a certain number of new AI models are associated with the model class. If the intra-class transfer score is lower (or is not higher) than the threshold value, the class split step can be applied to update the model class.

The following describes how the AI hyper-parameter optimizer 505 can identify 630 a similar training data set for an AI model.

A training data set associated with an AI model is associated with data property information, which is information describing properties of the training data set. The data property information includes training data set size and volume information, inter-data relationship information, and data element feature information. The AI hyper-parameter optimizer 505 can receive or obtain 605 the data property information.

Training data set size or volume information indicates the total number of data elements in the training data set.

Inter-data relationship information indicates inter-relationship or distribution features of data elements in the training data set. The information can be in the form of any of average inter-element distance, weighted mean values of data elements in the training data set (which can be computed as the geometric center), and statistical distribution of all data elements in the training data set.

Data element feature information describes or indicates features (structure, format, etc.) of each data element in the training data set. For example, for a training data set composed by figures, the data element features can include: resolution of each figure (numbers of pixels for width and height), dimensions of vectors representing each figure, labeled or unlabeled figure, etc.

Similarity between two training data sets, respectively associated with two different AI models, is measured by a data similarity level. The data similarity level is calculated based on data property information of the two training data sets, as the weighted average value of a property similarity indicator and a data sample similarity indicator. The property similarity indicator indicates weighted inverse differences, e.g. in the form of weighted summation of inverse difference values of selected properties of the two training data sets. In some embodiments, for a property that cannot be quantified, a lowest inverse difference value is be used if the property holds for all data element features in the two data sets, and a highest inverse difference value is used otherwise. The data sample similarity indicator indicates statistical differences (e.g., in the form of a mean difference, a variation difference) of two random sample sets respectively drawn from the two training data sets.

Given a first training data that is associated with a first AI model, i.e. the target AI model, the AI hyper-parameter optimizer 505 identifies a second training data set, associated with a second AI model, the second AI model being different from the first AI model, such that a data similarity level between the first training data and the second training data set is higher (or not lower) than a threshold value. Note that if multiple such second training data sets exist, the AI hyper-parameter optimizer 505 can identify one with highest similarity level, or an arbitrary one among the multiple such second training data sets. The identifying is according to data property information associated with the first training data set and data property information associated with the second training data set, and these information are received or obtained by the AI hyper-parameter optimizer 505 as part of the input information obtained 605 by the AI hyper-parameter optimizer 505.

The AI enabler 215 includes an encoder module 130 (encoder), which can be combined with a classifier 135 to form a complete target AI model 105. The classifier 135 is supplied by a service provider and implemented by a service function 225.

In some embodiments, the encoder 130 includes a shared sub encoder (also referred to as public sub encoder) which can be shared by a source AI model and the target AI model in a transfer learning for the target AI model, and two model-specific sub encoders (also referred to as private sub encoders) specific to the source AI model and the target AI model, respectively. The public sub encoder can be initialized during the transfer learning (when the transfer learning mode is the feature transfer mode or the mixed transfer mode), using encoder parameters of a model class that the target AI model belongs to (e.g. the model class being determined or identified 610 in embodiments associated with FIGS. 6a and 6b). The private sub encoders can be optional.

The AI enabler 215 further includes an evaluator module 530 (or evaluator for simplicity). The evaluator 530 evaluates at least one loss function during a training of the target AI model. The AI enabler 215 implements one or multiple loss functions. The evaluator can evaluate a single loss function, or a combination of multiple loss functions, among the one or multiple loss functions, according to configuration from the AI hyper-parameter optimizer 505.

When a transfer learning in the data transfer mode is to be applied to the training of the target AI model, the evaluator helps separate model-specific features and shared features within the encoder 130 into domain-specific sub encoders and the shared sub encoder, and generates feedback information for the encoder 130 and data selector 310.

The AI hyper-parameter optimizer 505 configures the AI enabler 215 to support the target AI model, by providing the AI enabler 215 with encoder structure information, encoder parameter information, and loss function information. The information, related to the target AI model can be described as follows.

Encoder structure information includes information, e.g. an encoder structure ID, indicating or identifying an encoder structure to be used. The encoder structure is determined by the AI hyper-parameter optimizer 505 according to the application category that the AI model is associated to. The AI hyper-parameter optimizer 505 can receive or obtain 605 information identifying the application category from a network entity. Encoder structure information can further indicate whether to activate or deactivate model-specific sub encoders in the encoder structure. The AI hyper-parameter optimizer 505 determines whether to activate or deactivate model-specific sub encoders in the encoder structure according to a transfer learning decision for the AI model. In some embodiments, the AI hyper-parameter optimizer 505 makes the transfer learning decision as illustrated in FIGS. 6a and 6b. For example, if the decision indicates that a transfer learning in the data transfer mode or in the mixed transfer mode is to be applied to a training of the AI model, the AI hyper-parameter optimizer 505 determines to activate the model-specific sub encoders, and deactivate them otherwise. The AI enabler 215 configures the encoder module 130 to use the encoder structure and to activate or deactivate the model-specific sub encoders, according to the encoder structure information.

Encoder parameter information can include encoder parameters for the shared sub encoder of the AI model. The encoder parameters are associated with a model class. The model class is determined or identified 610 by the AI hyper-parameter optimizer 50. The AI hyper-parameter optimizer 505 may obtain the encoder parameters from a feature base 305, which stores encoder parameters associated with every model class, e.g. by sending information (such as model class ID) identifying the model class to the feature base 305 and by receiving the corresponding the encoder parameters from the feature base 305. In some embodiments, this information (i.e. encoder parameter information) includes information (e.g. model class ID) that identifies the model class, and in this case, the AI enabler 215 provides the information identifying the model class to the feature base 305, and the AI enabler 215 receives the encoder parameters from the feature base 305. The AI enabler 215 uses the encoder parameters to initialize the shared sub encoder in the encoder module. When this information (i.e. encoder parameter information) is absent, the AI enabler 215 can initialize the shared sub encoder randomly, e.g. using randomly generated parameters.

Loss function information, e.g. in the form of a list of IDs, identifies one or multiple loss functions loss functions to be used by the evaluator 530, as well as the parameters associated with each of the one or multiple loss functions. If multiple loss functions are identified in the information about loss functions, this information indicates how the multiple loss functions are evaluated in combination by the evaluator. In some embodiments, this information indicates to apply a linear weighed combination of the multiple loss functions. In this case, this information includes weights corresponding to the multiple loss functions. The AI enabler 215 according to this information configures the evaluator module 530. The AI hyper-parameter optimizer 505 receives or obtains the loss function information from a network entity. The network entity can be the application controller (AC) 465 (which represents the service provider), or the service data repository 435 (which stores the information as part of a service profile).

After being configured by the AI hyper-parameter optimizer 505, the AI enabler 215 updates model parameters associated with the encoder 130 during the training of the AI model. To complete the backpropagation, the encoder 130 receives the input back-propagated from the classifier 135, i.e., the border gradients 230 which are related to the classifier border layer 145 (layer 4), and updates encoder parameters accordingly. To complete the forward propagation, the encoder border layer 140 (layer 3) transmits the border variables, which are calculated by the encoder 130 and related to the encoder border layer 140, to the classifier 135. For example, in FIG. 1, the border variables are intermediate training data after being processed by layer 1 to layer 3, whose dimension is the number of neurons in layer 3, times number of neurons in layer 4. The border gradients are corresponding weight derivatives of layer 3, back-propagated from layer 5 to layer 4, whose dimension is the number of neurons in layer 3, times the number of neurons in layer 4.

Meanwhile, control signals and selected training data are transmitted through an interface or connection T10b 449, between the AI enabler 215 and the data selector 310 in the privacy router 445, when training AI models.

The data selector 310 is an entity that selects training data to provide to the encoders in the AI enabler 215, and filters out data that has negative impact on the target AI model. The data selector 310 can be implemented as a filter function or an AI based solution. The configurations of the AI enabler 215 and the data selector 310 are jointly determined by the AI hyper-parameter optimizer 505. When the AI hyper-parameter optimizer determines the data transfer mode for the transfer learning, e.g. as illustrated in FIG. 6b, the AI hyper-parameter optimizer can activate or configure a selected data selector 310 and configure the AI enabler to provide performance feedback to the data selector 310. According to the performance feedback from the AI enabler, the data selector 310 can update the data selection rule to further minimize the negative impact on the target AI model. The performance feedback transmitted from the AI enabler to the data selector 310 can include a performance indicator and a data similarity indicator.

A performance indicator can represent the transfer learning performance evaluated by the evaluator 530 in the AI enabler 215. The lower the performance indicator is, the worse the data selection was done by the data selector 310. The contents of performance indicator can include accumulative gain produced by the reused AI model as output, real-time classification accuracy, convergence indicators (e.g., real-time mean variation), accumulative running time, etc.

A data similarity indicator measures the data set similarity between the target AI model's data set and the set of accumulative data selected by the data selector. The lower the data similarity indicator is, the worse the data selection was done by the data selector 310. The procedure to calculate data similarity indicator can be the same as the procedure to calculate training data set similarity.

This performance feedback from the AI enabler 215 to the data selector 310 can be transmitted via an interface or connection T10b 540 periodically, or each time a backpropagation is initiated

When routing information is related to an interface or connection, the routing information is prefixed with the name of the interface or connection for simplicity. For example, a routing information related to interface or connection T2 452 is referred to as T2 routing information.

When a prefixed routing information (e.g. a T2 routing information) is related to a network entity (e.g. a privacy router), the routing information describes or specifies how to reach the network entity over the corresponding interface or connection (e.g. T2), and it can include any of the following information related to the network entity: a network address, a port number, a protocol type, a tunnel end point ID, a tunnel ID, etc.

The above applies to any of the T2 routing information, T4 routing information, T8 routine information, T9b routing information, T10b routing information in the present disclosure.

A computing service is considered registered if the service data repository 435 stores a service profile of the computing service. The service profile of a computing service includes information (i.e. a service ID and/or a service name) identifying the computing service, as well as service description information (SDI). The SDI is provided by the application controller (AC) 465 and includes data (or information) describing the following from the computing service: service functions, works, tasks, and routines. The corresponding data are respectively referred to as service function data, work data, task data and routine data. The SDI can include information identifying the service provider that provides the computing service.

When the computing service is associated with one or multiple AI models (e.g. AI model 105), the SDI further includes model description information (MDI). For each of the one or multiple AI models, the MDI includes: information identifying the AI model, information identifying an application category, model goal information, loss function information, and transfer learning support indication.

Information identifying the AI model can be a model ID for example.

Information identifying an application category is for an application category associated with the AI model. In some embodiments, this information includes a category ID.

Model goal information describes a goal of the AI model. It can be in the form of a list of attribute values.

Loss function information can be in the form of a list of IDs identifying one or multiple loss functions to be used for training the AI model. This information can further include parameters associated with each of the one or multiple loss functions and information about how to combine the multiple loss functions.

Transfer learning support information indicates that a training of the AI model supports a transfer learning. In other words, it indicates that a transfer learning is supported during the training of the AI model. According to this information, as illustrated in FIGS. 6a and 6b, a service manager 410 including an AI hyper-parameter optimizer 505, i.e., the AI hyper-parameter optimizer 505 in the service manager 410, can decide to apply a transfer learning to the training of the AI model, or to use the AI model to help train another AI model. This information is optional and the absence of this information can imply that a transfer learning is not supported.

An AI model (e.g. AI model 105) identified in the MDI is associated with a routine. The routine belongs to a task, the task belonging to a work. The routine is related to a training of the AI model. Within the SDI, the routine data includes any of the following information for the routine: information identifying the routine, information identifying the AI model, information about the purpose of the routine, information identifying service functions, device information, and training data information.

Information identifying the routine, e.g. a routine ID, in some embodiments, includes information identifying a task to which the routine belongs. In some embodiments, this information includes information identifying a work to which the routine belongs.

Information identifying the AI model can be a model ID for example, as in the MDI.

Information about the purpose of the routine can indicate that the routine is related to a training of the AI model, and/or to an inference of the AI model.

Information identifying service functions can be function IDs. The routine is associated with two service functions. The two service functions are among those identified in the service function data. This information can indicate which one of the two service functions is a routine server function, and/or which of the service functions is a routine client function. In some embodiments, this information indicates that the routine client function represents or indicates devices. In some embodiments, when the purpose of the routine is related to training of the AI model, this information indicates that the routine client function represents a source of training data. In this case, the routine server function can implement the classifier 135 of the AI model 105.

Device information is about devices (e.g. UEs) represented by the routine client function associated with the routine. The devices identified in this information can, in other words, are allowed to, participate or join in an execution of the routine. They are viewed as instances of the routine client function. Device information is optional when the routine client does not represent devices. Device information can include information identifying the devices and information about potential or possible locations (or location area) of the devices.

Information identifying the devices can include a list of device IDs or network addresses, or a device group ID, or indicate that any device can be associated to the routine. Absence of this information can indicate that any device, or that a default device group (i.e. devices in the default device group) can be associated to the routine.

Information about potential or possible location (or location area) of the devices can include a list of zone IDs. Each zone can identify a geographic region. A zone ID can be in the form cell ID or RAN node ID.

Training data information is about training a data set to be used for the training of the AI model. The data set is represented (or provided) by the routine client function associated with the routine and identified by a function ID. In some embodiments, when the routine client function represents devices, the data set is provided collectively by devices represented by the service function. This information includes data property information described above.

When the computing service is associated with one or multiple AI modes as identified in the MDI, the service profile includes model data. For an AI model identified in the MDI, the model data can include information identifying the AI model, model hyper-parameter information, encoder structure information, loss function information, information about a transfer learning, information identifying the transfer learning, transfer learning mode information, source domain information model parameter information. These information elements are further described below.

Information identifying the AI model can be a model ID.

Model hyper-parameter information describes model hyper-parameters related to the AI model. The model hyper-parameter information is determined or generated by a service manager 410 including an AI hyper-parameter optimizer 505, i.e. the AI hyper-parameter optimizer 505 in the service manager 410. The service manager can be the one that serves the computing service. The model hyper-parameter information includes encoder structure information, loss function information and Information about a transfer learning.

Encoder structure information identifies an encoder structure to be used for the AI model, e.g. an encoder structure ID. The encoder structure is mapped by the service manager 410 including an AI hyper-parameter optimizer, i.e. the AI hyper-parameter optimizer 505 in the service manager 410, from the application category identified in the MDI. When a transfer learning is to be applied as indicated in the information about a transfer learning, the encoder structure is determined also according to the mode of the transfer learning. For example, if the transfer learning involves data transfer, the model-specific sub encoders are activated, and deactivated otherwise.

Loss function information can be in the form of a list of IDs identifying one or multiple loss functions to be used for training the AI model. This information can further include parameters associated with each of the one or multiple loss functions, and information about how to combine the multiple loss functions. This information is received by the service manager 410 including an AI hyper-parameter optimizer 505, i.e. the AI hyper-parameter optimizer 505 in the service manager 410, from the application controller 465, as part of the MDI.

Information about a transfer learning that is to be applied to a training of the AI model. When the MDI indicates that a transfer learning is supported during a training of the AI model, the service manager 410 including an AI hyper-parameter optimizer 505, i.e. the AI hyper-parameter optimizer 505 in the service manager 410, can determine to apply the transfer learning to the training of the AI model (e.g. as illustrated in FIGS. 6a and 6b) and generate this information accordingly. This information is optional when the service manager 410 including the AI hyper-parameter optimizer 505 determines not to apply a transfer learning to the training of the AI model. This information can include information identifying the transfer learning, transfer learning mode information, and source domain information.

Information identifying the transfer learning may include information identifying the computing service, information identifying the AI model, and information identifying a routine that is related to the training of the AI model, the routine belonging to the computing service.

Transfer learning mode information indicates which transfer mode is to be used in the transfer learning. It can indicate the data transfer mode, the feature transfer mode or the mixed transfer mode. The data transfer mode indicates that the transfer learning involves a data transfer. The feature transfer mode indicates that the transfer learning involves a feature transfer. The mixed transfer mode indicates the transfer learning involves a data transfer and a feature transfer.

Source domain information describes one or multiple source domains of the transfer learning, depending on the transfer learning mode indicated in the transfer learning mode information.

When the transfer learning involves a feature transfer as indicated in the transfer learning mode information, source domain information includes information identifying a model class to which the AI model belongs, e.g. a model class ID. The model class corresponds to a source domain of the transfer learning (more specifically, the feature transfer) and is identified or determined by the service manager 410 and AI hyper-parameter optimizer 505, according to model goal information identified in the MDI for the AI model.

When the transfer learning involves a data transfer, the transfer learning corresponds to, or identifies, a reuse of a work of the second computing service, wherein a routine of the work is reused to help train the AI model. Source domain information includes information identifying the reuse, which includes any of: information (a service ID) identifying the second computing service, information (e.g. a work ID) identifying the work, and information (e.g. a routine ID) identifying the routine. The reuse corresponds to a source domain of the transfer learning, more specifically the data transfer, and is determined by the service manager 410 including the AI hyper-parameter optimizer 505, according to training data information identified in the routine data for a routine related to the training of the AI model.

Model parameter information describes model parameters related to the encoder of the AI model, e.g., weights and biases of neurons in the encoder 130 of the AI model. This information is optional when the AI model is not trained. For an AI model, the model parameter information is stored or updated by an AI enabler supporting the AI model (via an interface or connection T10a 540), after the AI model has become well trained. The AI model is well trained after the training of the AI model converges or when the performance of the AI model is better than a pre-defined benchmark or threshold value. The model parameter information of the AI model can be used for calculating 695 or updating the encoder parameters of a model class such as the model class to which the AI model belongs, as described elsewhere in this disclosure (e.g. in embodiments associated with FIG. 6c).

The computing service is considered deployed if the service profile of the computing service further includes deployment data and compute plane data. Otherwise, it is considered un-deployed. If a computing service is deployed, it should be registered. The deployment of the computing service includes instances of the service functions of the computing service, and inter-connections between the service function instances. The deployment data describes deployment of the computing service. The computing plane data describes the computing plane associated with the computing service.

The deployment data is present after the computing service is deployed. This information includes service function instance information.

Service function instance information is information, such as a list of instance IDs, identifying service function instances, i.e. instances of service functions that are not abstract functions, as indicated in the service function data. An instance of a service function corresponds to a deployment location of the service function. The instance ID of the service function instance can include, or correspond to, information (e.g. function ID) identifying the service function and information identifying the deployment location (e.g. a location ID, network address or name). In some embodiments, this information further comprises T4 routing information for (related to) each of the service function instances. The T4 routing information can be used to reach the corresponding service function instance over interface T4.

The service function instance information can further include inter-function connectivity (connection) information.

Inter-function connectivity (connection) information (a.k.a. service function instance association information) is per routine. A routine is associated with a first service function (i.e. routine server function) and a second service function (i.e. routine client function). The second service function can represent devices but not necessarily, while the first service function does not represent devices. Inter-function connectivity (connection) refers to the association between an instance of the first service function and an instance of the second service function, and implies that the two service function instances will communicate or interact with each other during an execution of the routine (and are thus connected). The inter-function connectivity (connection) information indicates inter-function connectivity, i.e. which instance (identified by, e.g. an instance ID) of the second service function is associated or connected with which instance (identified by, e.g. an instance ID) of the first service function. The service function instances are among those identified in the service function instance information (described above).

The compute plane data is present after the computing service is deployed. This information can include privacy router information, privacy router interconnection information, routine manager information, and AI enabler information.

Privacy router information includes information identifying the privacy routers in the compute plane and, for each identified privacy router, information identifying its associated service function instance(s). The service function instances are among those identified in the deployment data, by the service function instance information.

Privacy router interconnection information indicates, for any pair of a first privacy router and a second privacy router, whether there is a connection or connectivity (i.e. a connection T8 448) between the first privacy router and the second privacy router (i.e. whether they are connected). The first privacy router and the second privacy router are among those identified in the privacy router information.

Routine manager information includes information (e.g. IDs or network addresses) identifying the routine manager(s) in the compute plane and, for each identified routine manager, information (e.g. routine ID) identifying the associated routine(s), and information, e.g. instance IDs, identifying service function instance(s) associated with each of the routine(s). The service function instance(s) are among those identified in the deployment data (by the service function instance information).

AI enabler information includes information (e.g. IDs or network addresses) identifying the AI enabler(s) in the compute plane and, for each identified AI enabler, information (e.g. routine ID) identifying the associated routine(s). For each of the associated routine(s), this information further includes information identifying privacy router(s) that are communicatively coupled with the AI enabler via an interface or connection T10b 540, and for each of the privacy routers, information indicating whether the privacy router is associated with a routine server and/or a routine client.

SDI in the service profile can be provided by the AC 465 during registration of the computing service.

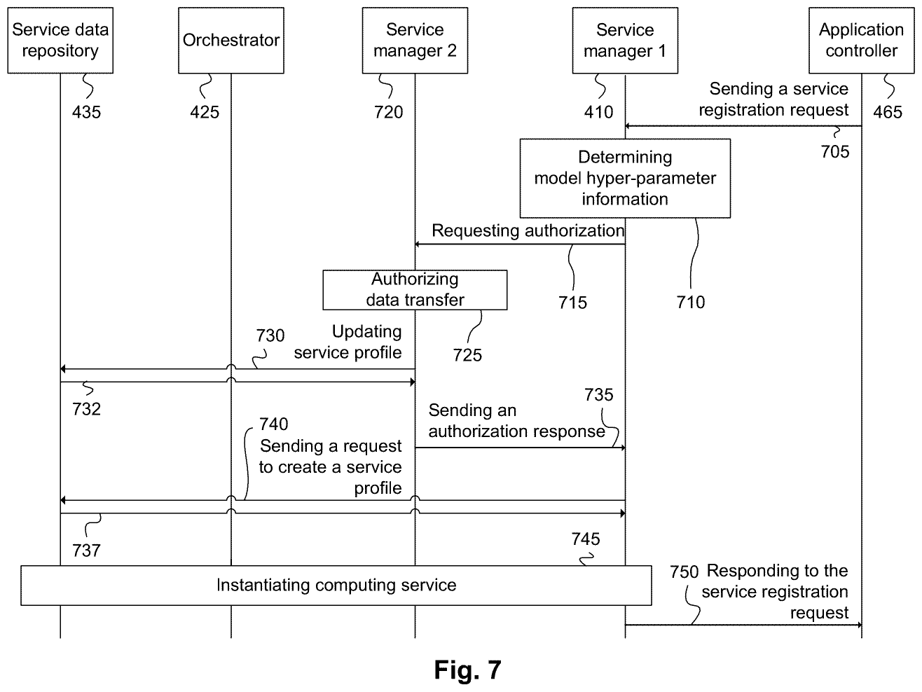

FIG. 7 illustrates a procedure of service registration for a first computing service, initiated by an application controller (AC) 465, according to an embodiment. The first computing service is associated with an AI model and includes a routine that is related to training of the AI model. During the procedure, a transfer learning is determined to be applied to the training of the AI model, and a service profile of the first computing service is created or updated in the service data repository 435.

If delayed deployment is not indicated by the application controller 465, the first computing service (in essence, service functions associated with the first computing service) is deployed or instantiated in the network during the service registration. The deployment of the first computing service includes instances of service functions associated with the first computing service and inter-function connections of the service functions. Furthermore, a compute plane is selected for the first computing service and associated with the deployment of the first computing service. The compute plane includes privacy routers 445 coupled (or associated) with the instances of the service functions. The compute plane also includes routine managers 440 corresponding to the routines within the first computing service. The compute plane further includes one or multiple AI enablers 215 to support the AI model associated with the first computing service.

Initially, the AC 465 requests to register the first computing service, by sending 705 a service registration request to a service manager 1 (410). The service registration request includes information (e.g. a service ID or name) identifying the first computing service and service description information (SDI) of the first computing service.

The SDI includes model description information (MDI) that identifies a first AI model and can further indicate that a transfer learning is supported during a training of the first AI model. The SDI indicates that a routine P of the first computing service is related to the training of the first AI model, the routine P being associated with a work X.

Then, the service manager 1 (410), which includes an AI hyper-parameter optimizer 505, determines 710 or generates model hyper-parameter information for the first AI model, according to the service registration request.

In some embodiments, when the MDI in the SDI indicates that the transfer learning is supported during the training of the first AI model, the service manager's 410 (AI hyper-parameter optimizer 505) determines (e.g. as illustrated in FIGS. 6a and 6b) to apply the transfer learning to the training of the first AI model, and determines (e.g. as illustrated in FIGS. 6a and 6b) the mode of the transfer learning and the source domain(s) of the transfer learning. In this case, the model hyper-parameter information includes information about the transfer learning. The information about the transfer learning includes source domain information and information indicating the mode of the transfer learning.

When the transfer learning involves a feature transfer (i.e. when the mode of transfer learning is feature transfer or mixed transfer), the source domain information identifies a model class as a source domain of the transfer learning (i.e. source domain of the feature transfer).

When the transfer learning involves a data transfer (i.e. when the mode of the transfer learning is data transfer or mixed transfer), the data transfer corresponds to a reuse, and the source domain information identifies the reuse. The reuse is a reuse of a work Y of the second computing service, wherein a routine Q of the work Y is reused to help train the first AI model, the routine Q being associated with a routine client function that represents a training data set and is related to a training of a second AI model. During the data transfer (i.e. the reuse), the training data set is used to train the first AI model. In this case, the source domain information indicates that the data transfer is to be supported by work Y and the routine Q of the second computing service.

Then, if the service manager 1 (410) (including an AI hyper-parameter optimizer 505) determines to apply the transfer learning and determines that the transfer learning involves a data transfer, the service manager 1 (410) requests 715 authorization from the service manager 2 (720) for the data transfer. Otherwise, this step is optional.

Requesting 715 authorization from the service manager 2 (720) can include the following sub steps.

The service manager 1 (410) requests 715 authorization for the data transfer from the service manger 2 (720) by sending an authorization request to the service manager 2. The service manager 1 can discover or select the service manager 2 using the information identifying the second computing service. The authorization request sent to the service manager 2 includes the information identifying the first computing service, the source domain information, and the information identifying the transfer learning. As described elsewhere in this application, the information identifying the transfer learning may include the information identifying the first computing service, the information identifying the AI model, and the information identifying a routine that is related to the training of the AI model, the routine belonging to the first computing service. The authorization request 715 can further include the information identifying the service provider that provides the first computing service.

The service manager 2 (720) authorizes 725 the data transfer according to the information in the authorization request 715. In some embodiments, the service manager 2 (720) identifies (e.g. in local storage) or obtains (e.g. from the service data repository) the service profile of the second computing service using the information identifying the second computing service, and the service manager 2 uses the information in the service profile of the second computing service to authorize the reuse.

In some embodiments, the service manager 2 (720) uses a network function (or entity), e.g. an AC that registered the second computing service, or an authentication, authorization and accounting (AAA) server, to authorize the data transfer. The service profile of the second computing service can indicate that the network function (or entity) is to be used for authorizing the reuse and include information (e.g. a domain name, an IP address) identifying the network function (or entity). The service manager 2 accordingly performs the authorization 725. That is, the service manager 2 sends the information identifying the service provider providing the first computing service and the information identifying the source domain of the data transfer to the network function (or entity), and the network function (or entity) sends the authorization result (i.e. information indicating whether the data transfer is authorized or allowed) to the service manager 2.

Then, if the data transfer is authorized or allowed, the service manager 2 (720) updates 730 the service profile of the second computing service to record the data transfer (i.e. the reuse). The service manager 2 makes a work Z correspond to the data transfer, that is, maps the information identifying the work Z to the combination of the information identifying the first computing service, and the information identifying the transfer learning. The service manager 2 stores the mapping in the service profile of the second computing service, by sending the information identifying the first computing service and the information identifying the transfer learning, and by indicating the mapping to the service data repository 435.

The work Z is a replica of the work Y and is generated by the service manager 2 in this step according to the data transfer, as follows.

The service manager 2 replicates the work Y (including composite tasks and composite routines, e.g. the routine Q) into the work Z. The service manager 2 allocates or generates information identifying the replicas, including a work ID identifying the replica work Z, task IDs identifying the replica tasks and routine IDs identifying the replica routines (e.g. the replica of the routine Q, referred to as routine Q′). The service manager 1 (410) stores the information in the service profile of the second computing service by sending the information to the service data repository.

The service manager 2 (720) maps the information identifying the replicas, e.g. the work Z and the routine Q′, to the information identifying the corresponding originals (e.g. the work Y, the routine Q) so that the replicas are correlated with their originals. The service manager 2 stores the mapping in the service profile of the second computing service, by sending or indicating the mapping to the service data repository 435.

The service data repository 435 stores the information received from the service manager 2 as part of the service profile of the second computing service. The service data repository can respond 732 to the service manager 2 (720), confirming that the information is stored successfully.

The service manager 2 (720) can respond to the service manager 1 (410) by sending 735 an authorization response to the service manager 1 (410). The authorization response includes an authorization result. The authorization result indicates that the data transfer (i.e. the reuse) is authorized or allowed. The authorization response further includes information indicating that the data transfer is to be supported by the work Z and the routine Q′. The information can include the information identifying the work Z and the information identifying the routine Q′.

The service manager 1 (410) processes the model hyper-parameter information (in particular the source domain information in the model hyper-parameter information), which has been determined 710, according to the authorization response, by replacing the information identifying the work Y (in the source domain information) with the information identifying the work Z, and by replacing the information identifying the routine Q (in the source domain information) with the information identifying the routine Q′. After the processing, the model hyper-parameter information (the source domain information in it) indicates that the data transfer is to be supported by work Z and the routine Q′. The service manager 1 (410) creates a service profile for the first computing service in the service data repository 435, by sending 740 a request to create a service profile in the service data repository 435. The request 740 includes the information identifying the first computing service. The request includes the SDI received from the AC's request 705, and the model hyper-parameter information.

The service profile is created 740 in the service data repository 435 for the first computing service. This includes storing information in the request as part of the service profile. The service data repository 435 can respond 437 to the service manager, indicating the service profile is created successfully.

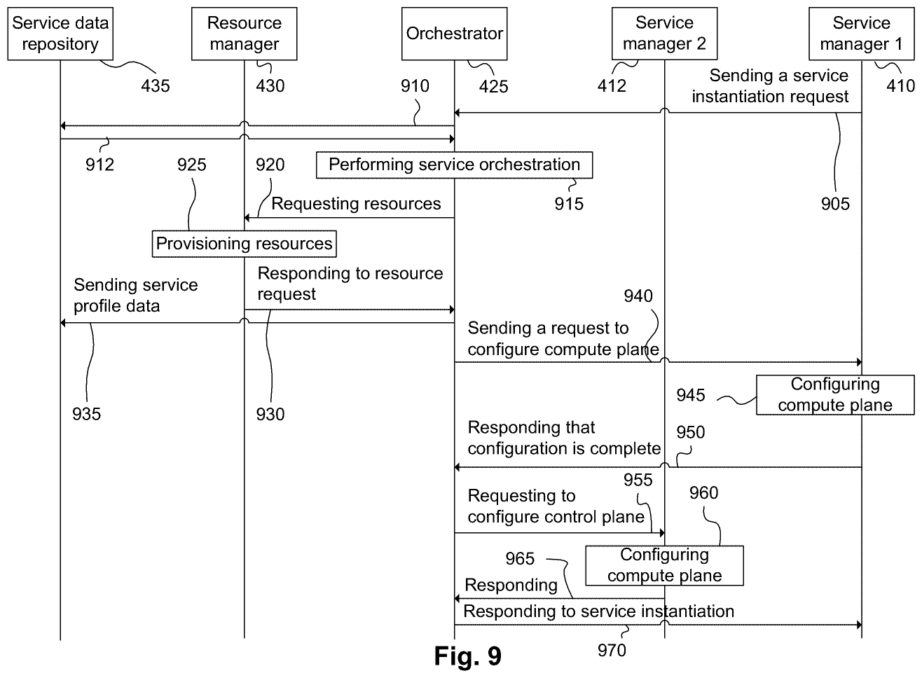

Then, the service manager 1 (410) instantiates 745 the first computing service according to the SDI and the model hyper-parameter information, through a service instantiation procedure illustrated in FIG. 9.

The service registration request 705 can indicate delayed instantiation (i.e. that the instantiation of the first computing service should be delayed), e.g. by including an indication of delayed instantiation. If the service registration request indicates delayed instantiation, this step is optional.

Then, the service manager 1 (410) can respond 750 to the application controller's 465 service registration request, to indicate that the requested service registration is completed or accepted.

After or during registration of the first computing service, that is associated with an AI model, the service manager 1 (410) can request the orchestrator 425 to instantiate the first computing service. The orchestrator accordingly performs service orchestration for the first computing service. This includes making a service deployment decision and a compute plane selection decision, both for the first computing service, according to the service profile of the first computing service. The orchestrator can make the service deployment decision and the compute plane selection decision jointly.

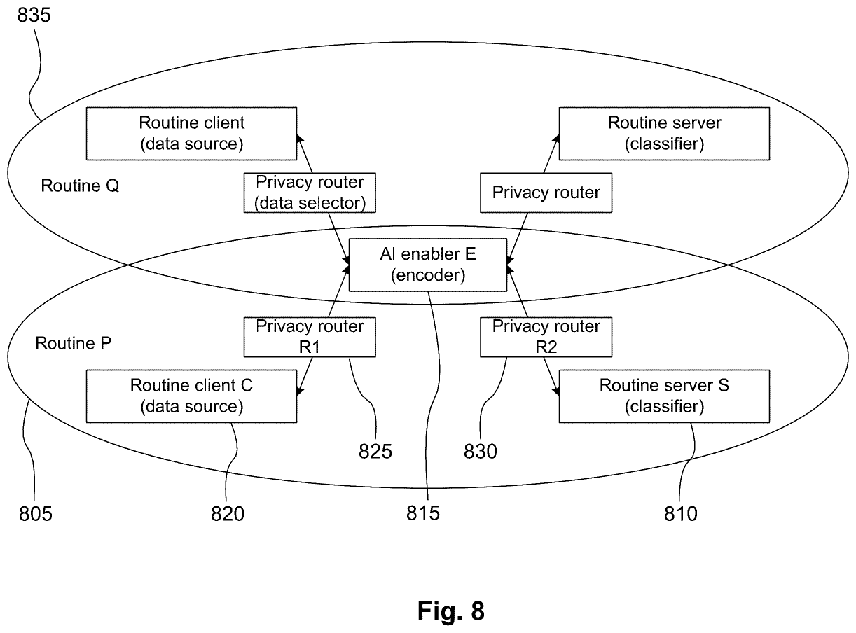

FIG. 8 illustrates compute plane entities for routine P 805 and routine Q 835, according to an embodiment. When making a service deployment decision, the orchestrator 425 determines deployment locations, i.e. network locations where service functions (those that are not symbolic functions) of the first computing service are to be deployed. A service function can be determined to have one or multiple deployment locations, i.e. be deployed or instantiated at one or multiple network locations.

After a service function is deployed or instantiated at a deployment location, there is an instance of the service function at the deployment location, e.g. in the form of a copy of the software implementing the service function. The service function instance is identified by an instance ID. In some embodiments, the instance ID includes the information identifying the deployment location and the information identifying the service function.

For each routine of the first computing service, the orchestrator determines inter-function connections of service function instances related to the routine.

As indicated in the service profile of the first computing service, a routine P 805 (referred to as the AI routine) of the first computing service is related to the AI model, e.g. related to a training of the AI model. The routine P 805 belongs to a work X in the first computing service. In this case, the routine server function 810 of the routine P implements a classifier 135 of the AI model.

When making the compute plane selection decision, the orchestrator determines or selects a compute plane for the first computing service. The compute plane includes one or multiple privacy routers 445 and one or multiple routine managers 440. The privacy routers are associated to the service function instances, while the routine managers correspond to routines associated with the computing service. The compute plane further includes at least one AI enabler E 815 to support the AI model according to the MDI and the routine data in the service profile of the first computing service.

Then, the at least one AI enabler E 815 is associated with the routine P 805. More specifically, the at least one AI enabler E is associated with one or multiple routine clients and at least one routine server, the one or multiple routine clients and the at least one routine server being respectively instances of the routine client function and an instance of the routine server function associated with the routine. Each of the one or multiple routine clients C 820 has an inter-function connection with one of the at least routine servers S 810, the inter-function connection being via a privacy router R1 825 associated with routine client C 820, a privacy router R2 830 associated with routine server S 810, and the AI enabler E 815. The AI enabler E 815 is topologically between the two privacy routers R1 825 and R2 830. In some embodiments, the two privacy routers R1 and R2 are implemented by the same entity.

Then, when selecting the compute plane, the orchestrator 425 selects the privacy router(s), the routine manger(s) and the AI enabler(s) from a pool of privacy routers 440, routine managers 445, and AI enablers. If there are no, or insufficient privacy routers or routine managers or AI enablers for selection, the orchestrator 425 can trigger to enlarge the pool, i.e. to deploy additional privacy routers and/or routine managers and/or AI enablers at selected network locations, and then select the privacy router(s) and/or the routine manager(s) and/or the AI enabler(s) from the enlarged pool.

In some embodiments, the work X in the first computing service reuses a work Z of the second computing service, as indicated in the model hyper-parameter information in the service profile of the first computing service. The reuse corresponds to a data transfer involved in a transfer learning, the transfer learning being applied to a training of the AI model, wherein a routine Q 835 of the work Z is reused to help train the AI model, the training of the AI model is related to the routine P 805. When performing service orchestration, the orchestrator can further make an incremental deployment decision and/or a compute plane reselection decision for the second computing service. The orchestrator provides the compute plane reselection decision for the second computing service to a service manager, e.g. service manager 2, serving the second computing service, which then implements the decision, i.e. reconfigures the compute plane for the second computing service accordingly.

When making the incremental deployment decision for the second computing service, the work Z is a replica, or a replica work of a work Y of the second computing service, e.g. as indicated in the service profile of the second computing service. In this case, the routine Q is a replica, or a replica routine of a routine of the second computing service. The orchestrator can make dynamic deployment decisions for the work Z (including the routine Q), including determining additional deployment locations and corresponding computing and network resource requirements of each service function of the work Z, and determining inter-function connections based on these additional deployment locations.

When making the compute plane reselection decision for the second computing service, the orchestrator 425 reselects the computing plane for the second computing service, according to the incremental deployment decision for the second computing service, and the service deployment decision for the first computing service. When the orchestrator reselects the computing plane, the orchestrator can reselect (or relocate), add, and/or remove some of the compute plane entities, such as routine managers, privacy routers, and AI enablers associated with the second computing service to optimize compute plane efficiency.

To support the reuse described above, the orchestrator 425 includes the at least one AI enabler E 815 in both the compute plane for the first computing service and the compute plane for the second computing service. The at least one AI enablers 815 is associated with both the routine P 805 and the routine Q 835 (shared by the compute planes of the two routines). Selecting the at least one AI enabler E 815 is among or part of the compute plane selection decisions for the first computing service, and also among or part of the compute plane reselection decision for the second computing service.

The orchestrator 425 interacts with the resource manager 430 to implement the deployment decisions, i.e. the service deployment decision for the first computing service and the incremental deployment decision for the second computing service.

The orchestrator 425 provides the compute plane selection decision for the first computing service to the service manager 410, and the service manager 410 implements the decision, i.e. configure the computing plane accordingly.

FIG. 9 illustrates a service instantiation procedure, in accordance with embodiments.

Initially, the service manager 1 (410) sends 905 a service instantiation request to the orchestrator 425. The request includes information (e.g. a service ID) identifying the first computing service. In some embodiments, the request includes information associated with the service profile of the first computing service. The information associated with the service profile of the first computing service can include the service profile, i.e. information in the service profile and in particular, the SDI and the model hyper-parameter information.

Then, the orchestrator 425 obtains service profiles related to the deployment request.

If the service instantiation request 905 does not include the service profile of the first computing service, the orchestrator 425 obtains the service profile of the first computing service from the service data repository 435, by sending 910 the information identifying the first computing service to the service data repository 435 and receiving 912 the corresponding service profile from the service data repository 435.

In some embodiments, when the first computing service reuses a second computing service for a data transfer, the service profile of the first computing service indicates a reuse (by the first computing) of a work Z of the second computing service, and includes information identifying the second computing service, and information identifying the work Z. In this case, the orchestrator 425 obtains the service profile of the second computing service from the service data repository 435, by sending the information identifying the second computing service (and possibly the information identifying the work Z) to the service data repository and receiving the corresponding service profile from the service data repository.

Then, the orchestrator performs 915 service orchestration according to the service profile of the first computing service and, if applicable, the service profile of the second computing service. When performing service orchestration, the orchestrator makes a service deployment decision and a compute plane selection decision, both for the first computing service, as described above, and if the first computing service reuses the second computing service, the orchestrator can further make an incremental deployment decision and a compute plane reselection decision, both for the second computing service, as described above.

Then, the orchestrator 425 notifies the deployment decision(s), including the service deployment decision for the first computing service and, if applicable, the incremental deployment decision for the second computing service, to the resource manager 430 for implementation, by requesting 920 appropriate resources. At this step, the orchestrator 425 can also provide software images of related service functions, or information identifying or locating the software images, to the resource manager 430.

Then, the resource manager 430 can implement the deployment decisions by instantiating or deploying the related service functions using corresponding software images and provisioning 925 compute resources and/or network resources according to corresponding resource requirements at respective deployment locations.

During or after the resource request 920 to the resource manager 430, the resource manager 430 receives the software image, or obtains the software images from some network locations, e.g. a server, or its own local storage, using the information identifying or locating the software image.

After a service function (e.g. one indicated in the service deployment decisions) is instantiated or deployed at a deployment location (e.g. a corresponding deployment location indicated in the service deployment decisions), there is an instance of the service function at the deployment location. The instance of the service function can be identified using information identifying the service function and information identifying the deployment location.

Then, the resource manager 430 responds 930 to the orchestrator 425, confirming the deployment decision(s) have been implemented, i.e. that related service function(s) have been instantiated or deployed. For each of the service function instances deployed, the resource manager 430 can include information identifying the service function instance (e.g. information identifying corresponding service function and information identifying the corresponding deployment location), and a T4 routine information associated with the service function instance in the response sent to the orchestrator.

The T4 routing information describes or specifies how to reach (communication with) the service function instance over an interface T4. It can include any of the following information related to the service function instance: a network address, a port number, a protocol type, a tunnel end point ID, a tunnel ID, etc. The T4 routing information can be generated and/or allocated by the resource manager 430 or received from the corresponding deployment location by the resource manager when it is providing 925 other resources and deploying the service function instance.

Then, the orchestrator 425 updates the related service profiles in the service data repository, by sending 935 service profile data to the service data repository 435.

To update 935 the service profile of the first computing service in the service data repository, the orchestrator 430 generates deployment data based on the service deployment decision for the first computing service and the T4 routine information related to the first computing service, which is received with resource response 930. The orchestrator generates compute plane data based on the compute plane selection decision for the first computing service.

The orchestrator 425 sends 935 the deployment data, the compute plane data and the information identifying the first computing service to the service data repository 435. The service data repository 435 stores the deployment data and the compute plane data in the service profile of the first computing service.

To update the service profile of the second computing service in the service data repository, the orchestrator 425 generates deployment data based on the incremental deployment decision for the second computing service and the T4 routine information related to the second computing service which is received 930 from the resource manager. The orchestrator generates compute plane data based on the compute plane reselection decisions for the second computing service and the service profile of the second computing service.

The orchestrator 430 sends 935 the deployment data, the compute plane data and the information identifying the second computing service to the service data repository 435. The service data repository 435 accordingly stores the deployment data and the compute plane data in the service profile of the second computing service, replacing the existing ones.

Then, the orchestrator interacts with the service manager to implement the compute plane selection decision for the first computing service. The orchestrator performs the following sub steps.

The orchestrator 425 requests 940 or triggers or indicates the service manager 1 (410) to configure the compute plane for the first computing service by sending 940 to the service manager 1 a request to configure the compute plane. The request to the service manager 1 includes the information identifying the first computing service.

In some embodiments, the request 940 includes the deployment data associated with the first computing service and the compute plane data associated with the first computing service. These data are generated by the orchestrator during service profile update 935.

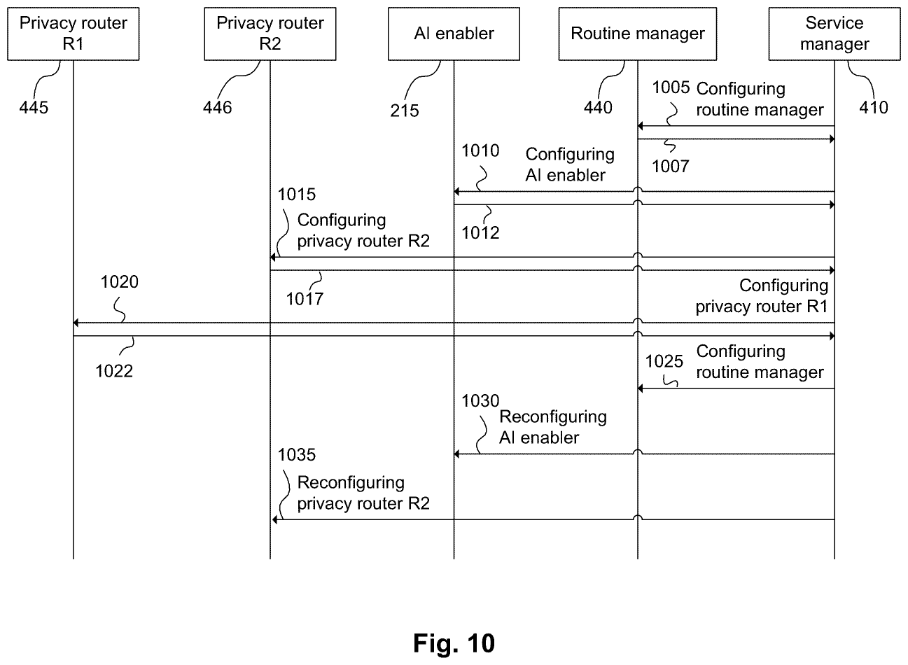

Then, the service manager 1 (410) configures 945 the computing plane for the first computing service, through a procedure illustrated in FIG. 10, according to the deployment data and the compute plane data received during request 940 to configure the compute plane. In some embodiments, when the orchestrator 425 does not provide these data during its request 940 to configure the compute plane, the service manager 1 (410) obtains these data from the service data repository 435 by sending the information identifying the first computing service to the service data repository, and receiving these data from the service data repository.

In this step, the service manager 1 (410) configures 945 the computing plane for the first computing service further according to model hyper-parameter information associated with the first computing service. In some embodiments, the service manager 1 (410) determines 710 the model hyper-parameter information. In some embodiments, the service manager 1 (410) obtains the model hyper-parameter information from the service data repository by sending the information identifying the first computing service to the service data repository and receiving the information from the service data repository.

The service manager 1 (410) can then respond 950 to the orchestrator 425, indicating that the configuration is complete.

In some embodiments, the following steps of FIG. 9 can run in parallel with the service manager 1 (410) configuring 945 a compute plane responding 950 to the orchestrator 425.

Then, the orchestrator 425 interacts with the service manager 2 (412) to implement the compute plane reselection decision for the second computing service. The service manager 2 (412) is a service manager that manages or is managing the second computing service. The orchestrator 425 selects or identifies the service manager 2 (412) using the information identifying the second computing service. The orchestrator 425 performs the following sub steps.

Initially, the orchestrator requests 955 or triggers or indicates the service manager 2 (412) to configure the compute plane for the second computing service by sending 955 a message to the service manager 2 (412). The message sent to the service manager 2 includes the information identifying the second computing service.

In some embodiments, the message 955 includes the deployment data associated with the second computing service and the compute plane data associated with the second computing service. These data can be generated earlier when the orchestrator 425 sends 935 a profile data to the service data repository 435.

Then, the service manager 2 (412) configures 960 the computing plane for the second computing service, through a procedure illustrated in FIG. 10, according to the deployment data and the compute plane data received during the orchestrator's request 955 to service manager 2 (412). In some embodiments, when the orchestrator does not provide these data with its request 955 to service manager 2, the service manager 2 obtains these data from the service data repository by sending the information identifying the second computing service to the service data repository and receiving these data from the service data repository.

Then, the service manager 2 (412) responds 965 to the orchestrator 425, indicating that the configuration is complete.

Then, the orchestrator 425 responds 970 to the service manager 1 (410) for the initial service instantiation request 905, by sending 970, optionally, a service instantiation response to the service manager 1 (410). For example, it can be optional in an embodiment where service manager 2 configures 960 the compute plane before service manager 1 configures 945 the compute plane.

A routine of a computing service, such as routine P 805 or routine Q 835, is associated with a task, which is in turn associated with a work. Both the task and the work are within the computing service. The computing service can include multiple routines. The routine P 805 is one of those routines. The routine P 805 is associated with a first service function F1 (i.e. routine client function), and a second service function F2 (i.e. routine server function). The routine P 805 is associated with an AI model 105 that is associated with the first computing service, e.g. the routine P 805 is related to a training or an inference of the AI model 105.

When the computing service is deployed 925, the deployment of the computing service includes a routine client FI1 (which is an instance of the routine client function F1) of the routine P and a routine server FI2 (which is an instance of the routine server function F2) of the routine P. The service profile of the computing service is updated 935 to include deployment data describing the deployment.

A compute plane is selected or reselected 915 for the computing service and associated with the deployment of the computing service. The compute plane includes one or multiple routine managers. Among the one or multiple routine managers, a routine manager is assigned to manage the routine P according to the two service function instances FI1 and FI2. The compute plane further includes a first privacy route R1 and a second privacy router R2, which are respectively associated with the two service function instances FI1 and FI2. The privacy routers R1 and R2 can be the same entity, e.g. when the two service function instances FI1 and F12 are associated with a same privacy router. The compute plane can further include an AI enabler E 815 that is associated with the two service function instances FI1 and FI2, for the AI model. The service profile of the computing service is updated 935 to include compute plane data describing the compute plane.

The service manager (410 or 412) serving the computing service configures (945 or 960) the compute plane, in accordance with the deployment data and the compute plane data. The service manager can obtain or receive the deployment data and the compute plane data from a network entity, e.g. from the service data repository 435 or from the orchestrator 425. When configuring the compute plane, the service manager performs a configuration procedure for the routine P 805, with respect to the service function instances FI1 and FI2.

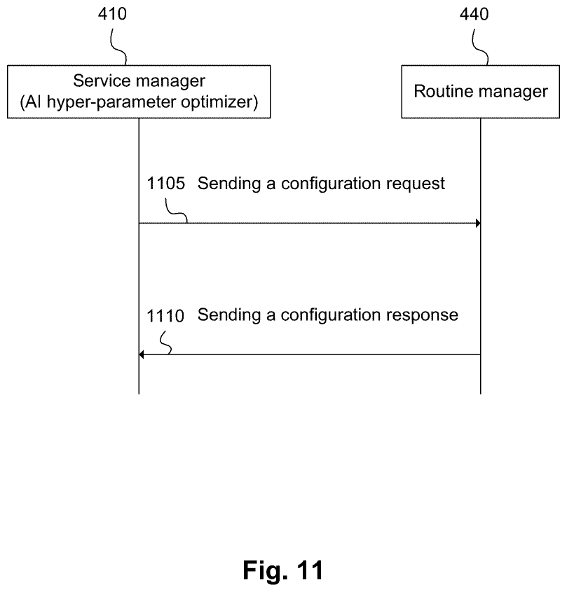

FIG. 10 is a procedure for configuring a compute plane for a routine, according to embodiments. Initially, the service manager, e.g. 410, including an AI hyper-parameter optimizer 505, configures 1005 the routine manager 440 (via a procedure illustrated in FIG. 11). In this step, the service manager 440 sends or provides the following information to the routine manager 440: information (e.g. service ID) identifying the computing service, information (e.g. routine ID) identifying the routine P, information (e.g. instance ID) identifying the service function instance FI1, information (e.g. instance ID) identifying the service function instance FI2, information (e.g. ID or network address) identifying the privacy router R1 445, and information (e.g. ID or network address) identifying the privacy router R2 446.

Then, the routine manager 440 sends or provides 1007 T9b routing information related to the routine manager 440, to the service manager 410. The service manager 410 will later provide the T9b routing information to privacy router R1 445 and privacy router R2 446, so that the privacy routers R1 and R2 can reach (e.g. route data or control signal to) the routine manager 410 for the routine using the information.

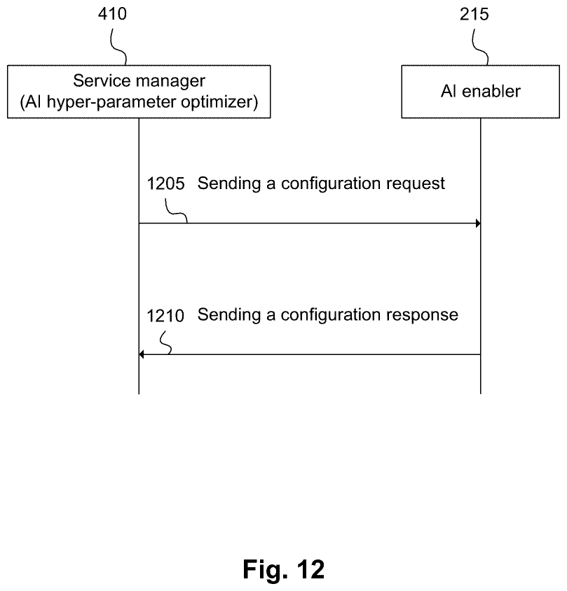

Then, the service manager 410 (the AI hyper-parameter optimizer 505), configures 1010 the AI enabler 215 (via a procedure illustrated in FIG. 12). In this step, the service manager 410 provides 1010 the information identifying the computing service, the information identifying the routine, the information identifying the task, and the model hyper-parameter information related to the AI model, to the AI enabler 215.

In this step, the AI enabler provides 1012 T10b routing information related to the AI enabler, to the service manager 410. The service manager will later provide the T10b routing information to the privacy router R1 and the privacy router R2, so that the privacy routers R1 and R2 can reach (e.g. route data or control signal to) the AI enabler 215 for the routine using the information.

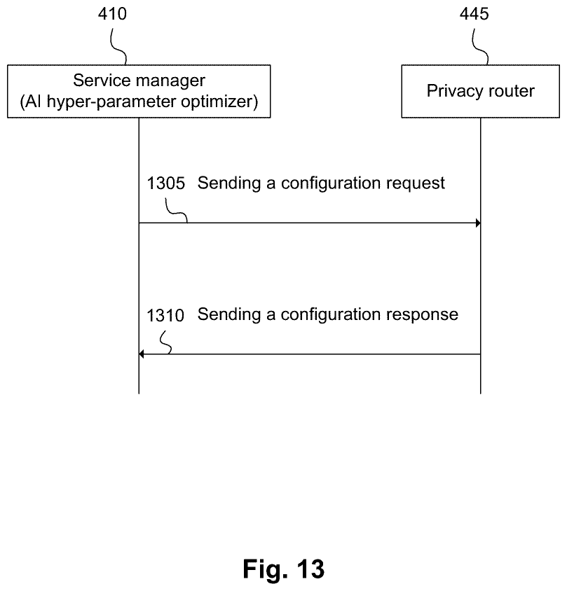

Then, the service manager 410 (AI hyper-parameter optimizer) configures 1015 the privacy router R2 446 (via a procedure illustrated in FIG. 13). In this step, the service manager 410 provides 1015 the following information to the privacy router R2: the information identifying the computing service, the information identifying the routine P, the T4 routing information related to the service function instance FI2, the T9b routing information related to the routine manager (received earlier), and the T10b routing information related to the AI enabler 215. The service manager can have obtained the T4 routing information related to the service function instance FI2 from the orchestrator 425, in an earlier step or an earlier procedure, e.g. from an orchestrator request 940 to configure a compute plane.

In this step, the privacy router R2 446 provides 1017 T8 routing information, T9b routing information and T10b routing information to the service manager 410. This routing information is related to the privacy router R2 446. The service manager 410 can later provide the T8 routing information related to the privacy router R2, to the privacy router R1 (so that privacy router R1 can route data to privacy router R2 for the routine using the information). The service manager 410 can also later provide the T9b routing information related to the privacy router R2, to the routine manager, and it can later provide the T10b routing information related to privacy router R2, to the AI enabler 215.

In this step, the privacy router R2 446 can further provide T4 routing information related to the privacy router R2, to the service manager 410. The service manager will then send the T4 routing information related to the privacy router R2, to the AC 465, which can further send it to the service function instance FI2. Alternatively, the privacy router R2 can send the T4 routine information related to the privacy router R2, to the service function instance FI2 directly (without involving the service manager), using the T4 routine information related to the service function instance FI2. The T4 routing information related to the privacy router R2 describes or specifies how to reach (e.g. route data or control signal to) the privacy router R2 for the routine over a connection or interface T4.

Then, the service manager 410 (AI hyper-parameter optimizer) configures 1020 the privacy router R1 445, via a procedure illustrated in FIG. 13.

In this step, the service manager 410 provides the following information to the privacy router R1 445: the information identifying the computing service, the information identifying the routine P, the T4 routing information related to the service function instance FI1, the T8 routing information related to the privacy router R2, received 1017 earlier, the T9b routing information related to the routine manager, received 1007 earlier, and the T10b routing information related to the AI enabler, received 1012 earlier. The service manager 410 can have obtained the T4 routing information related to the service function instance FI1 from the orchestrator, in an earlier step or an earlier procedure, e.g. in FIG. 9.

When the routine is related a training of the AI model, if it is determined that a transfer learning involving a data transfer is to be applied to the training of the AI model, and if the routine P corresponds to the source domain of the data transfer, as indicated in the model hyper-parameter information received 1012, the service manager instructs the privacy router R1 to activate the data selector functionality, i.e. to perform data selection upon data traffic received from the service function instance FI1. In this case, the service function (i.e. routine client function) F1 represents a training data set associated with the AI model.

In this step, the privacy router R1 445 provides 1022 T8 routing information, T9b routing information, and T10b routing information, to the service manager 410. This routing information is related to the privacy router R1. The service manager 410 can later provide the T8 routing information related to the privacy router R1, to the privacy router R2, so that the privacy router R2 can reach (e.g. route data to) the privacy router R1 for the routine using the information. The service manager 410 can also later provide the T9b routing information related to the privacy router R1, to the routine manager; and the T10b routing information related to privacy router R1, to the AI enabler.

In this step, the privacy router R1 can further provide T4 routing information related to the privacy router R1, to the service manager. The service manager can then send the T4 routing information related to the privacy router R1, to the AC, which can further send it to the service function instance FI1. Alternatively, the privacy router R1 can send the T4 routine information related to the privacy router R1, to the service function instance FI1 directly (without involving the service manager), using the T4 routine information related to the service function instance FI1. The T4 routine information related to the privacy router R1 describes or specifies how to reach (e.g. route data or control signal to) the privacy router R1 for the routine over a connection or interface T4.

Then, the service manager 440 (AI hyper-parameter optimizer) reconfigures 1025 the routine manager 440 (updates its configuration), via a procedure illustrated in FIG. 11. In this step, the service manager provides the T9b routing information related to the privacy router R2 received 1017 earlier, and the T9b routing information related to the privacy router R1 received 1022 earlier, to the routine manager.

Then, the service manager 410 (AI hyper-parameter optimizer) reconfigures 1030 the AI enabler 215 (updates its configuration), via a procedure illustrated in FIG. 12. In this step, the service manager 410 provides the T10b routing information related to the privacy router R2 (received 1017 earlier) and the T10b routing information related to the privacy router R1 (received 1022 earlier), to the AI enabler 215.

Then, the service manager 410 (with AI hyper-parameter optimizer) reconfigures 1035 the privacy router R2 (updates its configuration), via a procedure illustrated in FIG. 13. In this step, the service manager 410 provides the T8 routing information related to the privacy router R1 (received 1022 earlier) to the privacy router R2.

In an embodiment where the privacy router R1 and the privacy router R2 are the same entity, their configuration procedure can be combined, and reconfiguration of the combined entity can be optional. The configuration procedure assumes that the routine client function F1 does not represent devices.

During instantiation of a computing service, a compute plane is selected for the computing service. The computing plane includes a routine manager that is assigned to manage an execution of a routine within the computing service. The routine is associated with a first service function (called routine server function) and a second service function (called routine client function). The following is a procedure of configuring the routine manager, wherein the routine manager is provided with information about the routine and/or with information about a data sub plane (which is part of the compute plane) that is to be used to support (e.g. process and transport data traffic related to) the execution of the routine.

FIG. 11 illustrates a procedure for configuring a routine manager, according to an embodiment. Initially, the service manager 410 including an AI hyper-parameter optimizer 505 sends 1105 a configuration request to the routine manager 440. The configuration request includes information about the routine and/or information about the data sub plane. The information about the routine includes any of the following: information (e.g. a service ID) identifying the computing service, information (e.g. a routine ID) identifying the routine, information (e.g. a function ID) identifying the routine server function, and information (e.g. a function ID) identifying the routine client function.

The information about the data sub plane can include information about addition of service function instances, information about removal of service function instances, information about privacy routers.

The information about addition of service function instances can indicate that one or multiple instances of the routine server function are associated with the routine manager for the routine, e.g. by including information (e.g. one or multiple instance IDs) identifying the one or multiple instances of the routine server function. The information about addition of service function instances can indicate that one or multiple instances of the routine client function are associated with the routine manager 440 for the routine, e.g. by including information (e.g. one or multiple instance IDs) identifying the one or multiple instances of the routine server function. When the routine client function represent devices, the one or multiple instances of the routine server function are devices, and the information identifying the one or multiple instances of the routine server function includes IDs of the devices.

The information about removal of service function instances can that indicate one or multiple instances of the routine server function are no longer associated with the routine manager for the routine, e.g. by including information (e.g. one or multiple instance IDs) identifying the one or multiple instances of the routine server function. The information about removal of service function instances can indicate that one or multiple instances of the routine client function are no longer associated with the routine manager 440 for the routine, e.g. by including information (e.g. one or multiple instance IDs, or one or multiple device IDs) identifying the one or multiple instances of the routine server function.

The information about privacy routers can include, for a service function instance associated with the routine manager (e.g. every one of those identified in the information about addition of service function instances), information (e.g. an ID, a network address) identifying the privacy router associated with the service function instance. For an identified privacy router, the information about privacy routers may further include T9b routine information. The T9b routing information describes or specifies how to reach (e.g. route data to) the identified privacy router over a T9b connection or interface for the routine.

Then, the routine manager 440 sends 1110 a configuration response to the service manager 410 (AI hyper-parameter optimizer), acknowledging reception of the configuration request 1105. In the configuration response, the routine manager can include T9b routing information related to the routine manager 440. The T9b routing information describes or specifies how to reach (e.g. route data to) the routine manager 440 over a T9b connection or interface for the routine.

During instantiation of a computing service, a compute plane is selected for the computing service. The compute plane can include one or multiple routine managers 440 and one or multiple privacy routers 445. In some embodiments, the compute plane can further include one or multiple AI enablers 215.

An AI enabler 215 in a compute plane is associated with a routine within the computing service. The routine is related to an AI model 105 within the computing service, e.g. related to training of the AI model or inference based on the AI model. The AI enabler is further associated with one or multiple service function instances related to the routine. The one or multiple service function instances include at least one routine server, which is an instance of a routine server function associated with the routine. The one or multiple service function instances can further include one or multiple routine clients, which are instances of a routine client function associated with the routine. During an execution of the routine, the at least one routine server interacts or communicates with the one or multiple routine clients, via privacy routers that are associated with the at least one routine server interacts and/or the one or multiple routine clients.

The AI enabler 215 is communicatively coupled with the privacy router(s) so that the AI enabler can processes data traffic transmitted between the at least one routine server and the one or multiple routine clients, as described with FIG. 3b, during the routine execution. The following describes a procedure of configuring the AI enabler for the routine, with respect to the privacy routers.

FIG. 12 illustrates a procedure for configuring an AI enabler, according to an embodiment. Initially, the service manager 410 including an AI hyper-parameter optimizer 505 sends 1205 a configuration request to the AI enabler 215. The configuration request includes any of the following: information (e.g. a service ID) identifying the computing service, information (e.g. a routine ID) identifying the routine, and information (e.g. a model ID) identifying the AI model.

The configuration request 1025 can further include encoder structure information and loss function information, which are part of model hyper-parameter information related to the AI model. The AI enabler initializes or configures the encoder module according to the encoder structure information, so that the encoder module supports the AI model (e.g. supports a training of the AI model or an inference of the AI model) using the encoder structure identified in the encoder structure information. The AI enabler initializes or configures the evaluator module according to the loss function information, so that the evaluator module evaluates one or multiple loss functions identified in the loss function information during a training of the AI model.

The configuration request can further include information related to a transfer learning for the AI model. This information includes information identifying the transfer learning.

If the transfer learning involves feature transfer, the information related to the transfer learning further includes encoder parameters for the share sub encoder of the encoder of the AI model. The AI enabler uses the encode parameters to initialize the shared sub encoder in the encoder module. The encoder parameters correspond to the model class and are obtained by the service manager 410 from a feature base 305. The feature base 305 can be implemented or co-located with the service data repository 435.

If the transfer learning involves data transfer, the information related to the transfer learning can include information identifying a reuse, the reuse corresponding to the data transfer. The AI enabler 215 accordingly configures an evaluator module 530 to separate features specific to the source domain and those specific to the target domain respectively into the source-domain specific sub encoder and the target-domain specific sub encoder during the transfer learning, such that the shared sub encoder includes features that are common to or shared by the source domain and the target domain.

The configuration request 1205 can include information about the privacy router(s). The information can include information (e.g. IDs, network addresses) identifying the privacy router(s), and T10b routing information. The T10b routing information is per privacy router. For a privacy router, the corresponding T10b routing information describes or specifies how to reach (e.g. route data or control signal to) the privacy router over a connection or interface T10b, and the AI enabler 215 can use the information to route data or control signal to data or control signal related to the routine.

Then, the AI enabler 215 sends 1210 a configuration response to the service manager 410 (AI hyper-parameter optimizer 505), acknowledging reception of the configuration request 1205. The configuration response can include T10b routing information that is related to the AI enabler 215. The T10b routing information describes or specifies how to reach (i.e. route data or control signal) to the AI enabler for the routine over a connection or interface T10b.

During instantiation of a computing service, a compute plane is selected for the computing service. The compute plane can include one or multiple routine managers 440 and one or multiple privacy routers 445. The compute plane can further include one or multiple AI enablers 215.

A privacy router in the compute plane can be associated with a routine within the computing service, via a service function instance, the service function instance being an instance of a service function associated with the routine. The service function belongs to the computing service, i.e. it is native to the computing service. The service function instance can participate in an execution of the routine via the privacy router, e.g. by sending or receiving data traffic related to the execution of the routine via the privacy router. The privacy router is coupled with a routine manager in the compute plane, which is assigned to manage the routine with respect to the service function instance. In some embodiments, when the routine is related to an AI model, the privacy router is further coupled with an AI enabler in the compute plane for the routine. The AI enabler 215 includes an encoder 130 that is part of the AI model 105.

The following is a procedure for configuring the privacy router for the routine, with respect to the service function instance and, if applicable, the AI enabler.

FIG. 13 illustrates a procedure for configuring a privacy router, according to an embodiment. Initially, the service manager 410 including an AI hyper-parameter optimizer 505 sends 1305 a configuration request to the privacy router 445. The configuration request 1305 includes any of the following: information (e.g. a service ID) identifying the computing service, information (e.g. a routine ID) identifying the routine.

The configuration request can include T4 routing information, which is related to the service function instance. The privacy router can use the T4 routing information to route data (e.g. received from an interface or connection T8 or T10b) to the service function instance over a connection or interface T4.

The configuration request can include T10b routing information, which is related to the AI enabler. The privacy router can use the T10b routing information to route data (e.g. received from interface T4) or to control a signal (e.g. related to data selection) to the AI enabler, over a connection or interface T10b.

In some embodiments, when the routine is related to a transfer learning, and when the service function instance represents a data source, and when the service function instance is on the source side of the transfer learning (i.e. when the routine corresponds to the source domain of the transfer learning), then the configuration request can indicate to perform data selection upon reception of data traffic from the service function instance. According to this indication, the privacy router 445 can perform data selection or filtering upon data traffic received from the service function instance, as described earlier with a data selector 310. The privacy router 445 includes the data selector 310 as illustrated in FIG. 5.

Then, the privacy router 445 sends 1310 a configuration response to the service manager 410 having an AI hyper-parameter optimizer 505, acknowledging reception of the configuration request 1305. In the configuration response, the privacy router can include any of T4 routing information, T8 routing information, T9b routing information, and T10b routing information. These routing information are related to the privacy router 445 and they respectively describe or specify how to reach (e.g. route data traffic or control signal to) the privacy router 445 over connections or interfaces T4, T8, T9b, T10b for the routine. In some embodiments, the routing information can be used to reach the privacy router for other routines.

In this step, the privacy router R1 can send the T4 routing information related to the privacy router, to the service function instance using the T4 routing information related to the service function instance. The T4 routing information related to the service function instance is included in the configuration request 1305 received from the service manager. The service function instance can then use the T4 routing information related to the privacy router to reach the privacy router for the routine.

Embodiments can allow a reduction in the overhead of AI model development.

Embodiments can allow decisions to be made in the network instead of at the application layer, thereby relieving the application layer from transfer learning management overhead.

Embodiments can allow an encoder to be supplied and maintained by the network, which can lower maintenance costs of an AI model at the application layer.

Embodiments can allow transfer learning or a feature transfer mode to be more practical.

Embodiments can allow management of feature transfer at a model class granularity, rather than per pair of models.

Embodiments include an AI hyper-parameter optimizer having the functionality of automating transfer learning and related interfaces.

Embodiments include an AI enabler as an independent entity, resulting from a function separation of transfer learning, and having exposed interfaces for interaction between an application server (AS) and an AI enabler via a privacy router.

Embodiments include detailed procedures of service registration, service instantiation, and compute plane configuration, with respect to a hyper-parameter optimizer, an AI enabler and a data selector.

In embodiments, a device can be a network element, such as a UE, an IoT device, a vehicle, a satellite, and a server. A requirement for a device is that it can register with the platform as a device and be recognized by the platform as a device.

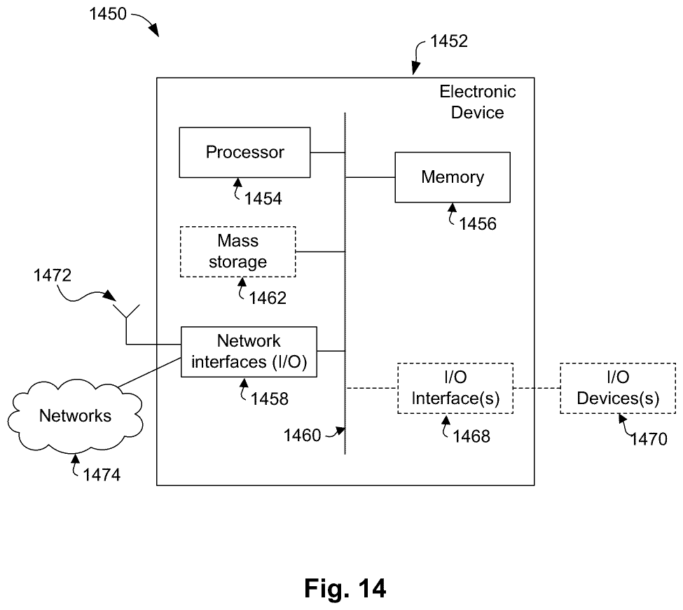

FIG. 14 is a block diagram of an electronic device (ED) 1452 illustrated within a computing and communications environment 1450 that may be used for implementing the devices and methods disclosed herein. In some embodiments, the electronic device 1452 may be an element of communications network infrastructure or a user equipment (UE). The electronic device 1452 typically includes a processor 1454, such as a central processing unit (CPU), and may further include specialized processors such as a graphics processing unit (GPU) or other such processor, a memory 1456, a network interface 1458 and a bus 1460 to connect the components of ED 1452. ED 1452 may optionally also include components such as a mass storage device 1462, a video adapter 1464, and one or more I/O interface 1468 (shown in dashed lines).

The memory 1446 can be any type of non-transitory system memory, readable by the processor 1454, such as static random-access memory (SRAM), dynamic random access memory (DRAM), synchronous DRAM (SDRAM), read-only memory (ROM), or a combination thereof. In specific embodiments, the memory 108 can include more than one type of memory, such as ROM for use at boot-up, and DRAM for program and data storage for use while executing programs.

The mass storage 1462 can be any type of non-transitory storage device configured to store data, programs, and other information and to make the data, programs, and other information accessible via the bus 1460. In some embodiments, mass storage 1462 may be remote to the electronic device 1452 and accessible through use of a network interface such as interface 1458. In the illustrated embodiment, mass storage 1462 is distinct from memory 1446 where it is included, and can generally perform storage tasks compatible with higher latency, but can generally provide lesser or no volatility. In some embodiments, mass storage 1462 can be integrated with a memory 1446 to form an heterogeneous memory.

In some embodiments, electronic device 1452 can be a standalone device, while in other embodiments electronic device 1452 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources can take the form of physical connections such as Ethernet or optical communications links, and can include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created

It should be appreciated that the network functions such as the AI hyper-parameter optimizer, the AI enabler, privacy routers, task, work and routine managers and the routine clients and servers can all be instantiated within one or more electronic devices. Accordingly, embodiments include one or more electronic devices including a processor and machine readable memory, storing machine executable instructions which when executed by the processor, cause the electronic device to implement the methods disclosed herein. Further a system of electronic devices and/or data centers can be used to implement the methods disclosed herein.

Embodiments include a method executed by an artificial intelligence (AI) hyper-parameter optimizer for transferring parameters between two applications comprising: obtaining, from a network entity, information indicating an application category of an AI model; determining an encoder structure of an encoder for the AI model; and configuring an AI enabler, according to the encoder structure; wherein the AI enabler is operative to transfer the parameters between two applications according to the AI model.

In embodiments, determining an encoder structure can comprise an AI hyper-parameter optimizer determining whether a feature transfer mode can be applied, determining whether a data transfer mode can be applied, and determining whether a mixed feature transfer mode and data transfer mode can be applied.

In embodiments, determining an encoder structure can comprise an AI hyper-parameter optimizer further comprising determining whether transfer learning can be applied, and determining a transfer learning mode and associated transfer learning information, wherein associated transfer learning information includes any of: parameters of the encoder, parameters of the source of training data, parameters for initializing the encoder, and information about a data source from which data can be transferred to train the AI model.

In embodiments, a method can further comprise an AI hyper-parameter optimizer identifying parameters of the encoder by classifying the AI model into a model class, and associating the parameters of the encode with the model class.

In embodiment, a method can further comprise an AI hyper-parameter optimizer calculating weighted means of the parameters of the encoder within a class of AI models, for obtaining an encoder parameter set for the class of AI models.

In embodiments, a method can further comprise an AI model further comprising an encoder comprising layers, and a classifier comprising layers.

In embodiments, a method can further comprise an AI enabler operative to obtain data from the routine client function, to convert the data into an internal representation of an AI model, and to send the internal representation of an AI model to the routine server function

In embodiments, a method can further comprise an AI enabler operative to obtain data from the routine client function, to convert the data into an internal representation of an AI model, and to send the internal representation of an AI model to the routine server function

In embodiments, a method can further comprise an AI enabler implementing an encoder comprising layers including at least one input layer; and an evaluator operative to evaluate at least one loss function during a training stage of the AI model.

In embodiments, a method can further comprise at least one privacy router further comprising a data selector operative to filter out data having a negative impact on a target AI model, and to send a set of selected training data to the AI enabler.

In embodiments, a method can further comprise a routine client function representing a source of training data, and a routine server function implementing a classifier.

In embodiments, a method can further comprise a routine client function representing a source of training data, and a routine server function implementing a classifier.

In embodiments, a method can further comprise an AI enabler obtaining from the routine server function, border gradients computed from the internal representation of the AI model; indicating to the routine client function to continue sending training data; and obtaining more training data from the routine client function, until a training data set has been processed.

In embodiments, a method can further comprise an AI hyper-parameter optimizer obtaining information describing one or more goals of the AI model, and obtaining information describing properties of the training data.

In embodiments, determining whether a feature transfer mode can be applied can comprise the AI hyper-parameter optimizer attempting to identify a model class of the AI model; and determining, if such a model class is successfully identified, that the feature transfer mode can be applied.

In embodiments, determining whether a data transfer mode can be applied can comprise an AI hyper-parameter optimizer attempting to identify a training data set, associated with a second AI model, that is similar to the training data set associated with the AI model, determining, if a training data set is successfully identified, that the data transfer mode can be applied.

In embodiments, a method can further comprise an AI hyper-parameter optimizer providing the AI enabler with information indicating the encoder structure, such that the information can be mapped from the information indicating the application category, to the AI enabler.

In embodiments, a method can further comprise an AI hyper-parameter optimizer determining whether there is sufficient training data, in the training data set associated with the AI model successfully identified, for a data transfer mode to be applied.

In embodiments, a method can further comprise an AI hyper-parameter optimizer sending a configuration request to the AI enabler, and receiving a configuration response from the AI enabler, wherein the configuration request to the AI enabler includes any of: information identifying the computing service, information identifying the routine, information identifying the AI model, encoder structure information, loss function information, information related to a transfer learning for the AI model, and information about the privacy router(s).

In embodiments, a method can further comprise an AI hyper-parameter optimizer sending a configuration request to a privacy router coupled to the AI enabler, and receiving a configuration response from the privacy router coupled to the AI enabler, wherein the configuration request to the privacy router includes any of: information identifying the computing service, information identifying the routine, information to activate a data selector, routing information related to the service function instance, and routing information related to an AI enabler.

Embodiments include a method of registering a computing service registration, comprising a first service manager that includes an artificial intelligence (AI) hyper-parameter optimizer receiving a service registration request from an application controller; determining model hyper-parameter information for a first AI model, according to the service registration request; requesting from a second service manager operative to authorize a data transfer, an authorization for a data transfer; receiving from the second service manager, an authorization response; and instantiating the computing service according to the model hyper-parameter information; wherein the service registration request includes information identifying the first computing service, and service description information (SDI) of the first computing service.

In embodiments, instantiating a computing service according to a model hyper-parameter information can comprise the first service manager that includes an artificial intelligence (AI) hyper-parameter optimizer sending to an orchestrator operative to perform a computing service orchestration, a service instantiation request; receiving from the orchestrator, a request to configure a compute plane for the computing service; configuring the compute plane for the computing service; sending to the orchestrator, a response indicating that configuring the compute plane is complete, the orchestrator being further operative to send to a second service manager, a request to configure the compute plane for a second computing service; wherein the second service manager is operative to configure the compute plane for the second computing service.

Embodiments have been described above in conjunction with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method executed by an artificial intelligence (AI) hyper-parameter optimizer for transferring parameters between two applications comprising:
obtaining, from a network entity, information indicating an application category of an AI model;
determining an encoder structure of an encoder for the AI model; and
configuring an AI enabler, according to the encoder structure;
wherein the AI enabler is operative to transfer the parameters between two applications according to the AI model.

2. The method of claim 1, further comprising determining whether transfer learning can be applied.

3. The method of claim 2, wherein determining whether transfer learning can be applied comprises:
determining whether a feature transfer mode can be applied,
determining whether a data transfer mode can be applied, and
determining whether a mixed feature transfer mode can be applied.

4. The method of claim 3, further comprising the AI hyper-parameter optimizer
classifying the AI model into a model class, and
identifying parameters of the model class.

5. The method of claim 4, further comprising the AI hyper-parameter optimizer calculating weighted means of the parameters of the model class.

6. The method of claim 1, wherein the AI model comprises
an encoder comprising layers, and
a classifier comprising layers.

7. The method of claim 1, wherein the AI enabler is operative
to obtain data from the routine client function;
to convert the data into an internal representation of an AI model; and
to send the internal representation of an AI model to the routine server function.

8. The method of claim 1, wherein the AI enabler implements an encoder comprising layers including at least one input layer.

9. The method of claim 1, wherein at least one privacy router further comprises a data selector operative
to filter out data having a negative impact on a target AI model, and
to send a set of selected training data to the AI enabler.

10. The method of claim 1, wherein
a routine client function represents a source of training data, and
a routine server function implements a classifier.

11. The method of claim 10, further comprising the AI enabler
obtaining from the routine server function,
border gradients computed from the internal representation of the AI model;
indicating to the routine client function to continue sending training data; and
obtaining more training data from the routine client function,
until a training data set has been processed.

12. The method of claim 1, further comprising the AI hyper-parameter optimizer
obtaining information describing one or more goals of the AI model, and
obtaining information describing properties of the training data.

13. The method of claim 2, wherein
determining whether a feature transfer mode can be applied comprises the AI hyper-parameter optimizer
attempting to identify a model class of the AI model;
determining, if such a model class is successfully identified,
that the feature transfer mode can be applied.

14. The method of claim 1, wherein
determining whether a data transfer mode can be applied comprises the AI hyper-parameter optimizer
attempting to identify a training data set, associated with a second AI model, that is similar to the training data set associated with the AI model,
determining, if a training data set is successfully identified, that the data transfer mode can be applied.

15. The method of claim 1, further comprising the AI hyper-parameter optimizer
providing the AI enabler with information indicating the encoder structure, such that the information can be mapped
from the information indicating the application category, to the AI enabler.

16. The method of claim 1, further comprising
the AI hyper-parameter optimizer
determining whether there is sufficient training data,
in the training data set associated with the AI model,
for a data transfer mode to be applied.

17. A method of registering a computing service registration, comprising
a first service manager that includes an artificial intelligence (AI) hyper-parameter optimizer
receiving a service registration request from an application controller;
determining model hyper-parameter information for a first AI model,
according to the service registration request;
requesting from a second service manager operative to authorize a data transfer,
an authorization for a data transfer;
receiving from the second service manager, an authorization response; and
instantiating the computing service according to the model hyper-parameter information;
wherein the service registration request includes
information identifying the first computing service, and
service description information (SDI) of the first computing service.

18. The method of claim 17, wherein
instantiating the computing service according to the model hyper-parameter information comprises
the first service manager that includes an artificial intelligence (AI) hyper-parameter optimizer
sending to an orchestrator operative to perform a computing service orchestration, a service instantiation request;
receiving from the orchestrator,
a request to configure a compute plane for the computing service;
configuring the compute plane for the computing service;
sending to the orchestrator,
a response indicating that configuring the compute plane is complete,
the orchestrator being further operative to send to a second service manager,
a request to configure the compute plane for a second computing service;
wherein the second service manager is operative to configure the compute plane for the second computing service.

19. An artificial intelligence (AI) hyper-parameter optimizer for transferring parameters between two applications comprising:
a processor; and
and at least one non-transitory machine readable medium storing machine readable instructions which when executed by the processor, configures the AI hyper-parameter optimizer for
obtaining, from a network entity, information indicating an application category of an AI model;
determining an encoder structure of an encoder for the AI model; and
configuring an AI enabler, according to the encoder structure;
wherein the AI enabler is operative to transfer the parameters between two applications according to the AI model.
